(19) United States
(12) Patent Application Publication
(10) Pub. No.: US 2016/0118638 A1
(43) Pub. Date: Apr. 28, 2016

(54) COMPOSITIONS FOR USE AS PROTECTIVE LAYERS AND OTHER COMPONENTS IN ELECTROCHEMICAL CELLS

(71) Applicants: Sion Power Corporation, Tucson, AZ (US); BASF SE, Ludwigshafen (DE)

(72) Inventors: Oliver Gronwald, Heusenstamm (DE); Benedikt Crone, Mannheim (DE); Ingrid Haupt, Frankenthal (DE); Raimund Pietruschka, Ebertsheim (DE); Anna Cristadoro, Waldems (DE); Bala Sankaran, Shelby Township, MI (US)

(73) Assignees: Sion Power Corporation, Tucson, AZ (US); BASF SE, Ludwigshafen (DE)

(21) Appl. No.: 14/921,381

(22) Filed: Oct. 23, 2015

Related U.S. Application Data
(60) Provisional application No. 62/068,015, filed on Oct. 24, 2014.

(51) Int. Cl. H01M 2/16; H01M 2/14

(52) U.S. Cl. CPC H01M 2/1673; H01M 2/1653; H01M 2/145

(57) ABSTRACT

Electrode structures and electrochemical cells, including lithium-sulfur electrochemical cells, are provided. The electrode structures and/or electrochemical cells described herein may include one or more protective layers comprising a polymer layer and/or a gel polymer electrolyte layer. Methods for making electrode structures including such components are also provided.

### RELATED APPLICATIONS

This application claims priority under 35 U.S.C. §119(e) to U.S. Provisional Patent Application Ser. No. 62/068,015, filed Oct. 24, 2014, and entitled “Compositions for Use as Protective Layers and Other Components in Electrochemical Cells,” which is incorporated herein by reference in its entirety for all purposes.

### FIELD

The present invention generally relates to polymer compositions for use as protective layers and other components in electrochemical cells (e.g., lithium-sulfur electrochemical cells). In some embodiments, electrode structures and/or methods for making electrode structures including an anode comprising lithium (e.g., metal or a lithium metal alloy) and a protective layer comprising the polymer composition are also provided.

### BACKGROUND

Lithium compound containing electric cells and batteries containing such cells are modern means for storing energy. They exceed conventional secondary batteries with respect to capacity and life-time and, in many times, use of toxic materials such as lead can be avoided. However, in contrast to conventional lead-based secondary batteries, various technical problems have not yet been solved.

Secondary batteries based on cathodes based on lithiated metal oxides such as LiCoO₂, LiMn₂O₄, and LiFePO₄ are well established, see, e.g., EP 1 296 391 A1 and U.S. Pat. No. 6,962,666 and the patent literature cited therein. Although the batteries mentioned therein exhibit advantageous features, they are limited in capacity. For that reason, numerous attempts have been made to improve the electrode materials. Particularly promising are so-called lithium sulfur batteries. In such batteries, lithium will be oxidized and converted to lithium sulfides such as Li₂S₈₋ₐ, a being a number in the range from zero to 7. During recharging, lithium and sulfur will be regenerated. Such secondary cells have the advantage of a high capacity.

A particular problem with lithium sulfur batteries is the thermal runaway which can be observed at elevated temperatures between, e. g., 150 to 230° C. and which leads to complete destruction of the battery. Various methods have been suggested to prevent such thermal runaway such as coating the electrodes with polymers. However, those methods usually lead to a dramatic reduction in capacity. The loss in capacity has been ascribed—amongst others—to formation of Lithium dendrites during recharging, loss of sulfur due formation of soluble lithium sulfides such as Li₂S₃, Li₂S₄ or Li₂S₆, polysulfide shuttle, change of volume during charging or discharging and others. There are also other problems and challenges with lithium sulfur batteries.

Despite the various approaches proposed for forming electrodes and protective layers, improvements are needed.

### SUMMARY

The present invention generally relates to polymer composition for use as protective layers and other components in electrochemical cells (e.g., electrochemical cells comprising lithium and sulfur). The subject matter of the present invention involves, in some cases, interrelated products, alternative solutions to a particular problem, and/or a plurality of different uses of one or more systems and/or articles.

In certain embodiments, an electrode structure is provided. The electrode structure includes, in some embodiments, an electrode comprising lithium metal or lithium alloy, a polymer layer comprising a cross-linked polymeric material formed by reaction of:
(aa) a polymeric material formed by reaction of:
   (a) at least one polyimide selected from condensation products of:
      (a1) at least one polyisocyanate having on average at least two isocyanate groups per molecule and
      (a2) at least one polycarboxylic acid having at least 3 COOH groups per molecule or an anhydride thereof and
   (b) at least one organic amine comprising at least one primary or secondary amino group, or a mixture of at least one organic amine comprising at least one primary or secondary amino group and at least one diol or triol and
(bb) at least one polyisocyanate having on average at least two isocyanate groups per molecule.

In certain embodiments, a method for fabricating an electrode structure is provided. The method involves, in some embodiments, positioning on an electrode a polymer layer comprising a cross-linked polymeric material formed by reaction of:
(aa) a polymeric material formed by reaction of:
   (a) at least one polyimide selected from condensation products of:
      (a1) at least one polyisocyanate having on average at least two isocyanate groups per molecule and
      (a2) at least one polycarboxylic acid having at least 3 COOH groups per molecule or an anhydride thereof and
(b) at least one organic amine comprising at least one primary or secondary amino group, or a mixture of at least one organic amine comprising at least one primary or secondary amino group and at least one diol or triol and
(bb) at least one polyisocyanate having on average at least two isocyanate groups per molecule.

In some embodiments, an electrode structure comprises as component (A) at least one electrode comprising lithium metal or lithium alloy, and lithium ion conductively connected thereto as component (D) one or more polymer layers comprising at least one cross-linked polymeric material obtainable by reaction of
(aa) a polymeric material obtainable by reaction of
(a) at least one polyimide selected from condensation products of
(a1) at least one polyisocyanate having on average at least two isocyanate groups per molecule and,
(a2) at least one polycarboxylic acid having at least 3 COOH groups per molecule or anhydride thereof,
   with
(b) at least one organic amine comprising at least one primary or secondary amino group, or a mixture of at least one organic amine comprising at least one primary or secondary amino group and at least one diol or triol,
   with
(bb) at least one polyisocyanate having on average at least two isocyanate groups per molecule.

In some embodiments, a lithium sulfur electrochemical cell is provided. The cell comprises at least one electrode structure described herein. The lithium sulfur electrochemical cell is obtainable by assembling an electrode structure described herein and a non-aqueous electrolyte (C), wherein the electrode structure and the non-aqueous electrolyte (C) are brought into contact so that the at least one polymer layer (D) is at least partially, e.g., completely, dissolved in the non-aqueous electrolyte (C).

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows an article for use in an electrochemical cell according to one set of embodiments;

FIG. 2 shows an electrochemical cell according to one set of embodiments.

### DETAILED DESCRIPTION

Polymer compositions including polymer compositions for use in electrochemical cells are provided. In some embodiments, a polymer composition comprises a polyimide, e.g., a branched polyimide. The disclosed polymer compositions may be incorporated into an electrochemical cell (e.g., a lithium-sulfur electrochemical cell) as, for example, a protective layer for an electrode, a polymer gel electrolyte, a separator, a release layer, and/or any other appropriate component within the electrochemical cell. In certain embodiments, electrode structures and/or methods for making electrode structures including an anode comprising lithium metal or a lithium metal alloy and a protective layer comprising a polymer composition described herein are provided.

Lithium as an anode material offers several advantages over other materials due to, for example, its negative electrochemical potential and in combination with other materials its wide electrochemical window and its light weight and thus highest gravimetric energy density among all metallic anode materials. An anode comprising lithium be used with any suitable cathode, as described herein. In certain embodiments, the active cathode material in a lithium battery comprises sulfur. Concentration of sulfur in the cathode may vary, for example, between about 30 wt % and about 80 wt %. In some embodiments, further additives are added to the active cathode material (e.g., due to the electronically insulation properties of sulfur). In certain embodiments, the additives may be conductive. In some embodiments, the additives comprise carbon (e.g., ranging between about 20 wt % and about 60 wt %). For example, in certain embodiments, the cathode comprises about 55 wt % sulfur as active material and about 40 wt % carbon matrix. In certain embodiments, the additives comprise a binder (e.g., ranging between about 1 wt % and about 10 wt %). In some cases, the presence of a binder may maintain the mechanical integrity of the cathode layer. Other configurations of anodes and cathodes, as well as other components in an electrochemical cell, are also possible.

Rechargeable lithium-sulfur (Li/S) batteries are believed to be very promising alternative power sources for long driving range (>300 km) pure electric vehicles (PEV's) and plug-in electric vehicles (PHEV) since current lithium-ion batteries (LIB) based on intercalation materials can potentially provide only energy densities up to 200 Wh kg⁻¹. This novel type of battery system offers much higher energy density and is relatively inexpensive. Theoretical energy density values can approach 2500 Wh kg⁻¹ with practical values of 500 to 600 Wh kg⁻¹ assuming the complete electrochemical conversion of sulfur (S₈) to lithium sulfide (Li₂S). Therefore, Li/S batteries have been investigated for mobile and portable applications, especially high energy applications.

Currently quick capacity fading and low sulfur utilization are the main obstacles for using Li/S as rechargeable system. Only about 50% or ˜800 mAhg⁻¹ of 1672 mAhg⁻¹ as theoretical capacity can be used. One reason may be the “polysulfide shuttle” mechanism. The elemental sulfur molecules accept electrons during the first discharge process and are gradually converted from higher order to lower order polysulfides. Lower polysulfides with less than three sulfur atoms (Li₂S₃) are insoluble in the electrolyte so that the following reduction step to the insoluble and electronically non-conductive Li₂S₂ is hampered. Thus low discharge efficiencies are observed at rates higher than C/10. In addition, the polysulfides are not transformed to elemental sulfur during the charging cycles. Instead of being oxidized to sulfur in the final step, the higher order polysulfides constantly diffuse to the anode where they are being gradually reduced by the elemental lithium to lower polysulfides in a parasitic reaction. The soluble lower polysulfides then diffuse back to the cathode thus establishing the “polysulfide shuttle”. Insoluble lower polysulfides precipitate from the electrolyte and accumulate on the anode side. In summary, the mechanism reduces charge efficiency and causes corrosion on anode and cathode. As result Li/S batteries suffer from capacity fading and a lack of cycle lifetime. Typical state of the art Li/S battery systems can reach lifetimes of 50-80 cycles.

The disclosed polymer compositions may be incorporated into electrochemical cells, for example, primary batteries or secondary batteries, which can be charged and discharged numerous times. In some embodiments, the materials, systems, and methods described herein can be used in association with lithium batteries (e.g., lithium-sulfur batteries). The electrochemical cells described herein may be employed in various applications, for example, making or operating cars, computers, personal digital assistants, mobile telephones, watches, camcorders, digital cameras, thermometers, calculators, laptop BIOS, communication equipment or remote car locks.

In some embodiments, the polymers disclosed herein may be employed in electrode structures. For example, the electrode structures may include an electroactive layer (e.g., an anode or a cathode) and one or more polymer layers (e.g., as a protective layer for an electrode, a polymer gel electrolyte, a separator, a release layer), optionally, present in a multi-layered structure. The multi-layered structure may include one or more ion conductive layers (e.g., a ceramic layer, a glassy layer, or a glassy-ceramic layer) and one or more polymer layers comprising the polymers disclosed herein disposed adjacent to the one or more ion conductive layers. The resulting structures may be highly conductive to electroactive material ions and may protect the underlying electroactive material surface from reaction with components in the electrolyte. In another set of embodiments, an electrochemical cell may include a gel polymer electrolyte layer comprising the disclosed polymer compositions. In some cases, such protective layers and/or gel polymer layers may be suitable for use in an electrochemical cell including an electroactive material comprising lithium (e.g., metallic lithium). In some embodiments, the polymer layer may be adjacent the anode. In some embodiments, the polymer layer may be adjacent the cathode. In some embodiments, an electrochemical cell comprises at least one protective layer adjacent the anode, and the polymer layer is positioned between the protective layer and the cathode.

In some embodiments, the polymers disclosed herein may be employed in an electrochemical cell comprising at least one electrode structure. In some cases, the electrochemical cell may be fabricated by providing an electrode structure, one or more polymer layers, and a non-aqueous electrolyte, wherein the electrode structure and the non-aqueous electrolyte are brought into contact such that the one or more polymer layers are at least partially dissolved in the non-aqueous electrolyte. In certain embodiments, the one or more polymer layers are completely dissolved in the non-aqueous electrolyte. In some such embodiments, the one or more polymer layers may be a release layer.

In some embodiments, an electrochemical cell comprises a polymer composition comprising a branched polyimide. In some embodiments, the polymer is a reaction product of
(aa) a polymeric material obtainable by reaction of
   (a) at least one polyimide selected from condensation products of
      (a1) at least one polyisocyanate having on average at least two isocyanate groups per molecule and,
      (a2) at least one polycarboxylic acid having at least 3 COOH groups per molecule or anhydride thereof, and
   (b) at least one organic amine comprising at least one primary or secondary amino group, or a mixture of at least one organic amine comprising at least one primary or secondary amino group and at least one diol or triol, and
(bb) at least one polyisocyanate having on average at least two isocyanate groups per molecule. In some embodiments, the polymer is branched but not crosslinked. In other embodiments, the polymer is branched and crosslinked.

In some embodiments, the polymer is crosslinked by reacting polymeric material (aa) with at least one polyisocyanate (bb), which has on average at least two isocyanate groups per molecule. In certain embodiments, the polymer (e.g., the crosslinked polymeric material) is an insoluble material (e.g., insoluble in an electrolyte contained within the electrochemical cell). The crosslinked polymeric material may include, for example, a polymer network wherein at least a portion of the initial macromolecules is connected chemically (e.g., by covalent bonding, ionic bonding) to more than two others.

As noted above and as described in more detail herein, in some embodiments, an electrochemical cell comprising an anode comprising lithium metal or a lithium alloy, a polymer layer comprising a crosslinked polymeric material, and a cathode comprising sulfur is provided, wherein said crosslinked polymeric material is formed by reaction of:
(aa) a polymeric material formed by reaction of
   (a) at least one polyimide selected from condensation products of
      (a1) at least one polyisocyanate having on average at least two isocyanate groups per molecule and,
      (a2) at least one polycarboxylic acid having at least 3 COOH groups per molecule or anhydride thereof, and
   (b) at least one organic amine comprising at least one primary or secondary amino group, or a mixture of at least one organic amine comprising at least one primary or secondary amino group and at least one diol or triol, and
(bb) at least one polyisocyanate having on average at least two isocyanate groups per molecule. The polymer layer may function as a protective layer for the anode or cathode, as a polymer gel electrolyte, as a release layer, and/or as a separator. In one embodiment, the polymer layer is a protective layer for the anode (e.g., comprising lithium metal or a lithium alloy) and/or the cathode (e.g., comprising sulfur). In another embodiment, the polymer layer is a release layer (e.g., for the formation of an electrode structure).

In some embodiments, polymeric material (aa) is formed by reacting at least one polyimide (a) with at least one organic amine (b) comprising at least one primary or secondary amino group. In certain embodiments, polymeric material (aa) is formed by reacting at least one polyimide (a) with a mixture of at least one organic amine (b) comprising at least one primary or secondary amino group and at least one diol or triol. In some embodiments, polymeric material (aa) is a soluble polymer. For example, polymeric material may be processed, in some cases, by solvent cast technology in order to form thin films during the production of separators, which are themselves insoluble in solvents, which are used in electrolytes of electrochemical cells.

In certain embodiments, polyimide (a) is a condensation product of at least one polyisocyanate (a1) having on average at least two isocyanate groups per molecule and at least one polycarboxylic acid (a2) having at least 3 COOH groups per molecule or anhydride thereof. In some embodiments, polyimide (a) is linear or branched. In some cases, polyimide (a) may be soluble in polar solvents. In some such embodiments, the polar solvent may be aprotic. Non-limiting examples of suitable polar aprotic solvents include amides including dimethylacetamide, dimethylformamide or N-methyl pyrrolidone, ethers like tetraglyme, diglyme, 1,2-dimethoxyethane, 1,3-dioxolane or tetrahydrofuran (THF), and carbonates including dimethyl carbonate, ethyl methyl carbonate, diethyl carbonate ethylene carbonate, propylene carbonate or vinylene carbonate.

In some embodiments, the molecular weight (weight average molecular weight, M_{w}) of polyimide (a) may be greater than or equal to about 1000 g/mol, greater than or equal to about 5000 g/mol, greater than or equal to about 10,000 g/mol, greater than or equal to about 15,000 g/mol, greater than or equal to about 20,000 g/mol, greater than or equal to about 50,000 g/mol, greater than or equal to about 100,000 g/mol, greater than or equal to about 200,000 g/mol. Further, the molecular weight of polyimide (a) may be less than or equal to about 200,000 g/mol, less than or equal to about 100,000 g/mol, less than or equal to about 50,000 g/mol, less than or equal to about 20,000 g/mol, less than or equal to about 15,000 g/mol, less than or equal to about 10,000 g/mol, or less than or equal to about 5000 g/mol. Combinations of the above are possible (e.g., a molecular weight of greater than or equal to about 500 g/mol and less than or equal to about 200,000 g/mol, or greater than or equal to about 2000 g/mol and less than or equal to about 20,000 g/mol). Other combinations are also possible. Other ranges are also possible. In one particular set of embodiments, polyimide (a) has a molecular weight M_{w} of 500 to 200,000 g/mol or 2,000 to 20,000 g/mol. The molecular weight can be determined by known methods, in particular by gel permeation chromatography (GPC).

Polyimide (a) may include any suitable number of imide groups per molecule. In some embodiments, polyimide (a) comprises at least two imide groups per molecule. In certain embodiments, polyimide (a) comprises at least 3 imide groups per molecule. In certain instances, polyimide (a) includes at least 5, 10, 15, 20, 50, 100, 200, or 500 imide groups per molecule. In some embodiments, polyimide (a) may have up to 1,000 imide groups per molecule, or up to 660 imide groups per molecule. Stating the number of groups per molecule (e.g., imide groups, isocyanate groups, COOH groups per molecule) in each case denotes the mean value (number-average).

Polyimide (a) may be composed of structurally and molecularly uniform molecules. In some embodiments, polyimide (a) is a mixture of molecularly and structurally differing molecules, for example, visible from the polydispersity Mw/Mn (weight average molecular weight/number average molecular weight) of at least 1.4, at least 1.5, at least 2, at least 5, at least 10, at least 15, at least 20, at least 30, at least 40; and/or less than or equal to 50, less than or equal to 40, less than or equal to 30, less than or equal to 20, less than or equal to 10, less than or equal to 5, less than or equal to 4, or less than or equal to 3. Combinations of the above are possible (e.g., a polydispersity of at least 1.4 and less than or equal to 50, at least 1.5 and less than or equal to 10, or at least 2 and less than or equal to 4). In one particular set of embodiments, polyimide (a) has a polydispersity between 1.4 to 50, or between 1.5 to 10. The polydispersity can be determined by known methods, in particular by gel permeation chromatography (GPC). A suitable standard is, for example, poly(methyl methacrylate) (PMMA).

In some embodiments, polyimide (a), in addition to imide groups which form the polymer backbone, comprises, terminally or in side chains, at least 3, or at least 6, or at least 10, at least 20, at least 50, at least 100, or at least 200 terminal or side-chain functional groups. Functional groups in polyimide (a) may include, for example, anhydride or acid groups and/or free or capped NCO groups. In some embodiments, the functional groups do not include alkyl groups such as, for example, methyl groups. In some embodiments, polyimide (a) may have no more than 500, no more than 200, no more than 100, no more than 50, or no more than 10 terminal or side-chain functional groups. Combinations of the above are possible (e.g., at least 2 and no more than 100 functional groups). Other ranges are also possible.

In some embodiments, polyisocyanate (a1) can be selected from, or includes one or more of, polyisocyanates that have on average at least 2 (e.g., at least 3, at least 4, at least 5) isocyanate groups per molecule which can be present capped, or may be free. Non-limiting examples of polyisocyanates (a1) are diisocyanates, for example, hexamethylene diisocyanate, isophorone diisocyanate, toluylene diisocyanate, 4,4′-diphenylmethane diisocyanate, 2,4′-diphenylmethane diisocyanate, or mixtures of at least two of the above mentioned polyisocyanates (a1). Non-limiting examples of mixtures include mixtures of 4,4′-diphenylmethane diisocyanate and 2,4′-diphenylmethane diisocyanate and mixtures of 2,4-toluylene diisocyanate and 2,6-toluylene diisocyanate.

In some embodiments, polyisocyanate (a1) is selected from oligomeric hexamethylene diisocyanate, oligomeric tetramethylene diisocyanate, oligomeric isophorone diisocyanate, oligomeric diphenylmethane diisocyanate, oligomeric toluylene diisocyanate, or mixtures of at least two of the above mentioned polyisocyanates (a1). For example, what is termed trimeric hexamethylene diisocyanate is in many cases not the pure trimeric diisocyanate, but the polyisocyanate having a mean functionality of 3.6 to 4 NCO groups per molecule. The same applies to oligomeric tetramethylene diisocyanate and oligomeric isophorone diisocyanate.

In some embodiments, polyisocyanate (a1) is a mixture of at least one diisocyanate and at least one triisocyanate or a polyisocyanate having at least 4 isocyanate groups per molecule. In some embodiments, polyisocyanate (a1) has on average exactly 2.0 isocyanate groups per molecule. In other embodiments, polyisocyanate (a1) has on average at least 2.2, or at least 2.5, or at least 3.0 isocyanate groups per molecule. In some embodiments, polyisocyanate (a) has, on average, between 2 and about 2.5 isocyanate groups per molecule. In some embodiments, polyisocyanate (a1) has, on average, 2 isocyanate groups per molecule. In some embodiments, polyisocyanate (a1) has on average up to 8, or up to 6, isocyanate groups per molecule. In some embodiments, polyisocyanate (a1) is selected from oligomeric hexamethylene diisocyanate, oligomeric isophorone diisocyanate, oligomeric diphenylmethane diisocyanate, or mixtures of the above mentioned polyisocyanates.

In some embodiments, polyisocyanate (a1), in addition to urethane groups, can also have one or more other functional groups, for example urea, allophanate, biuret, carbodiimide, amide, ester, ether, uretonimine, uretdione, isocyanurate, or oxazolidine functional groups.

In some embodiments, polycarboxylic acids (a2) such as aliphatic or aromatic polycarboxylic acids, or the respective anhydride or ester thereof, that have at least 3 (e.g., at least 4, at least 5, at least 6) COOH groups per molecule, may be selected. The aliphatic or aromatic polycarboxylic acids may be in a relatively low-molecular weight form, e.g., in a monomeric or non-polymeric form. In some embodiments, the polycarboxylic acids having at least 3, 4, 5, 6 COOH groups include at least one carboxylic acid group (e.g., 2 carboxylic acid groups) that are present as anhydride and at least one free carboxylic acid. For example, those polycarboxylic acids having 3 COOH groups in which two carboxylic acid groups are present as anhydride and the third as free carboxylic acid are also possible. In some embodiments, as polycarboxylic acid (a2), a polycarboxylic acid, or the respective anhydride or ester thereof, having at least 4 COOH groups per molecule is selected. In some embodiments, a polycarboxylic acid (a2), or the respective anhydride or ester thereof, has on average 3 COOH or on average 4 COOH groups per molecule. In some embodiments, polycarboxylic acids (a2), or an anhydride or ester thereof, has at least 4 COOH groups per molecule. In some embodiments, a polycarboxylic acid (a2) has at least 3 or at least 4 anhydride groups.

Non-limiting examples of polycarboxylic acids (a2) and anhydrides thereof are 1,2,3-benzenetricarboxylic acid and 1,2,3-benzenetricarboxylic monoanhydride, 1,3,5-benzenetricarboxylic acid (trimesic acid), 1,2,4-benzenetricarboxylic acid (trimellitic acid), trimellitic anhydride, or 1,2,4,5-benzenetetracarboxylic acid (pyromellitic acid) and 1,2,4,5-benzenetetracarboxylic dianhydride (pyromellitic dianhydride), 3,3′,4,4′-benzophenonetetracarboxylic acid, 3,3′,4,4′-benzophenonetetracarboxylic dianhydride, in addition benzenehexacarboxylic acid (mellitic acid) and anhydrides of mellitic acid.

Other non-limiting examples of polycarboxylic acids and anhydrides thereof include mellophanic acid and mellophanic anhydride, 1,2,3,4-benzenetetracarboxylic acid and 1,2,3,4-benzenetetracarboxylic dianhydride, 3,3,4,4-biphenyltetracarboxylic acid and 3,3,4,4-biphenyltetracarboxylic dianhydride, 2,2,3,3-biphenyltetracarboxylic acid and 2,2,3,3-biphenyltetracarboxylic dianhydride, 1,4,5,8-naphthalenetetracarboxylic acid and 1,4,5,8-naphthalenetetracarboxylic dianhydride, 1,2,4,5-naphthalenetetracarboxylic acid and 1,2,4,5-naphthalenetetracarboxylic dianhydride, 2,3,6,7-naphthalenetetracarboxylic acid and 2,3,6,7-naphthalenetetracarboxylic dianhydride, 1,4,5,8-decahydronaphthalenetetracarboxylic acid and 1,4,5,8-decahydronaphthalenetetracarboxylic dianhydride, 4,8-dimethyl-1,2,3,5,6,7-hexahydronaphthalene-1,2,5,6-tetracarboxylic acid and 4,8-dimethyl-1,2,3,5,6,7-hexahydronaphthalene-1,2,5,6-tetracarboxylic dianhydride, 2,6-dichloronaphthalene-1,4,5,8-tetracarboxylic acid and 2,6-dichloronaphthalene-1,4,5,8-tetracarboxylic dianhydride, 2,7-dichloronaphthalene-1,4,5,8-tetracarboxylic acid and 2,7-dichloronaphthalene-1,4,5,8-tetracarboxylic dianhydride, 2,3,6,7-tetrachloronaphthalene-1,4,5,8-tetracarboxylic acid and 2,3,6,7-tetrachloronaphthalene-1,4,5,8-tetracarboxylic dianhydride, 1,3,9,10-phenanthrenetetracarboxylic acid and 1,3,9,10-phenanthrenetetracarboxylic dianhydride, 3,4,9,10-perylenetetracarboxylic acid and 3,4,9,10-perylenetetracarboxylic dianhydride, bis(2,3-dicarboxyphenyl)methane and bis(2,3-dicarboxyphenyl)methane dianhydride, bis(3,4-dicarboxyphenyl)methane and bis(3,4-dicarboxyphenyl)methane dianhydride, 1,1-bis(2,3-dicarboxyphenyl)ethane and 1,1-bis(2,3-dicarboxyphenyl)ethane dianhydride, 1,1-bis(3,4-dicarboxyphenyl)ethane and 1,1-bis(3,4-dicarboxyphenyl)ethane dianhydride, 2,2-bis(2,3-dicarboxyphenyl)propane and 2,2-bis(2,3-dicarboxyphenyl)propane dianhydride, 2,3-bis(3,4-dicarboxyphenyl)propane and 2,3-bis(3,4-dicarboxyphenyl)propane dianhydride, bis(3,4-carboxyphenyl)sulfone and bis(3,4-carboxyphenyl)sulfone dianhydride, bis(3,4-carboxyphenyl) ether and bis(3,4-carboxyphenyl) ether dianhydride, ethylenetetracarboxylic acid and ethylenetetracarboxylic dianhydride, 1,2,3,4-butanetetracarboxylic acid and 1,2,3,4-butanetetracarboxylic dianhydride, 1,2,3,4-cyclopentanetetracarboxylic acid and 1,2,3,4-cyclopentanetetracarboxylic dianhydride, 2,3,4,5-pyrrolidinetetracarboxylic acid and 2,3,4,5-pyrrolidinetetracarboxylic dianhydride, 2,3,5,6-pyrazinetetracarboxylic acid and 2,3,5,6-pyrazinetetracarboxylic dianhydride, 2,3,4,5-thiophenetetracarboxylic acid and 2,3,4,5-thiophenetetracarboxylic dianhydride.

In some embodiments, anhydrides from U.S. Pat. Nos. 2,155,687 or 3,277,117, which are incorporated herein by reference in their entireties for all purposes, are used for the synthesis of polyimide (a).

If polyisocyanate (a1) and polycarboxylic acid (a2) are condensed with one another (e.g., in the presence of a catalyst) then an imide group can be formed with elimination of CO₂ and H₂O. If, instead of polycarboxylic acid (a2), the corresponding anhydride is used, then an imide group can be formed with elimination of CO₂.

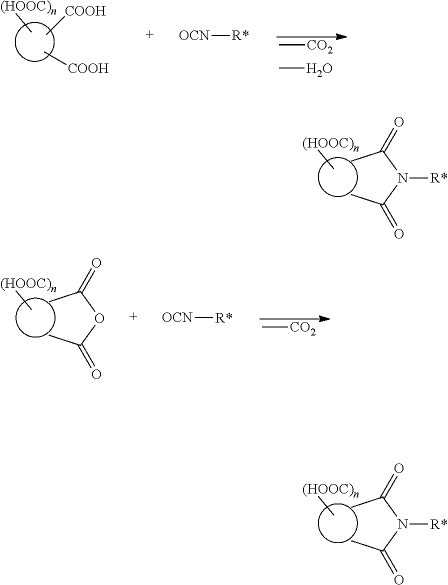

In the above reaction equations, R* is the radical of polyisocyanate (a1), and n is a number greater than or equal to 1; for example, 1 in the case of a tricarboxylic acid or 2 in the case of a tetracarboxylic acid, wherein (HOOC)ₙ can be replaced by an anhydride group of the formula C(═O)—O—C(═O).

In some embodiments, polyisocyanate (a1) is used in a mixture with at least one diisocyanate selected from the group consisting of toluylene diisocyanate, hexamethylene diisocyanate and with isophorone diisocyanate. In one set of embodiments, polyisocyanate (a1) is used in a mixture with the corresponding diisocyanate. For instance, combinations may be selected from trimeric HDI with hexamethylene diisocyanate, trimeric isophorone diisocyanate with isophorone diisocyanate, and polymeric diphenylmethane diisocyanate (“polymer MDI”) with diphenylmethane diisocyanate.

In certain embodiments, polycarboxylic acid (a2) is used in a mixture with at least one dicarboxylic acid or with at least one dicarboxylic anhydride, for example, in a mixture with phthalic acid or phthalic anhydride.

For carrying out the synthesis method for making polyimides (a) polyisocyanate (a1) and polycarboxylic acid (a2) or anhydride (a2) can be used (e.g., reacted together) in a quantitative ratio such that the molar fraction of NCO groups to COOH groups is in the range from 1:3 to 3:1, or from 1:2 to 2:1. In this case, one anhydride group of the formula CO—O—CO counts as two COOH groups.

In some embodiments, organic amine (b) comprises at least one primary or secondary amino group. In certain embodiments, organic amine (b) is selected from amines comprising one, two or three primary or secondary amino groups (e.g., monoamines, diamines, or triamines). In some embodiments, the molecular weight of the organic amine (b) (e.g., M_{w}) may be greater than or equal to about 31 g/mol, greater than or equal to about 100 g/mol, greater than or equal to about 200 g/mol, greater than or equal to about 500 g/mol, greater than or equal to about 1,000 g/mol, greater than or equal to about 2,000 g/mol, greater than or equal to about 5,000 g/mol, or greater than or equal to about 7,000 g/mol. Further, the molecular weight of the organic amine (b) may be less than or equal to about 10,000 g/mol, less than or equal to about 7,000 g/mol, less than or equal to about 5,000 g/mol, less than or equal to about 2,000 g/mol, less than or equal to about 1,000 g/mol, less than or equal to about 500 g/mol, less than or equal to about 200 g/mol, or less than or equal to about 100 g/mol. Combinations of the above are possible (e.g., a molecular weight of greater than or equal to about 31 g/mol and less than or equal to about 10,000 g/mol, or greater than or equal to about 100 g/mol and less than or equal to about 5,000 g/mol). Other combinations are also possible. Other ranges are also possible.

Non-limiting examples of organic monoamines include methylamine, octadecylamine, Jeffamine® M 2070 (formula PEA a, M_{w} approximately 2000 g/mol, PO/EO mol ratio of 10/31), taurine, dibutylamine and di-n-tridecylamine. Non-limiting examples of organic diamines include Jeffamin® D 230 (formula PEA b, M_{w} approximately 230 g/mol, x ˜2.5), Jeffamin® ED 600 (formula PEA c, M_{w} approximately 600 g/mol, PO/EO mol ratio of 1.2/2.0), hexamethylenediamine, isophorone diamine, piperazine and N,N′-dimethylhexane-1,6-diamine. Non-limiting examples of organic triamines include Jeffamin® T-403 (formula PEA e, M_{w} approximately 440 g/mol, R=Ethyl, n=1, x+y+z=5 to 6), Jeffamin® T-5000 (formula PEA e, M_{w} approximately 5000 g/mol, R=H, n=0, x+y+z ˜85) and N′,N′-bis(2-aminoethyl)ethane-1,2-diamine.

In some embodiments, organic amines (b) comprising at least one primary or secondary amino group, are selected from aliphatic amines with a C₈ to C₅₀-alkyl group (e.g., C₁₀ to C₃₀-alkyl group, or C₁₄ to C₁₈-alkyl group), polyetheramines containing one, two or three primary amino groups attached to the ends of a polyether backbone (e.g., wherein the polyether backbone comprises propylene oxide (PO), ethylene oxide (EO) or mixed PO/EO), and organic acids comprising at least one primary or secondary amino group. In certain embodiments, the organic amine (b) is taurin (2-aminoethanesulfonic acid).

In certain embodiments, aliphatic amines are selected from the group consisting of methylamine, octadecylamine, dibutylamine, di-n-tridecylamine, hexamehylenediamine, isophorone diamine, piperazine, N,N′-dimethylhexane-1,6-diamine and N′,N′-bis(2-aminoethyl)-ethane-1,2-diamine. In some embodiments, the aliphatic amine is octadecylamin.

A broad variety of different structural types of polyetheramines are commercially available, e.g., as JEFFAMINE® from Huntsman. In some embodiments, polyetheramines are monoamines of general formula PEA a, diamines of general formulae PEA b, PEA c and PEA d, and triamines of general formula PEA e.

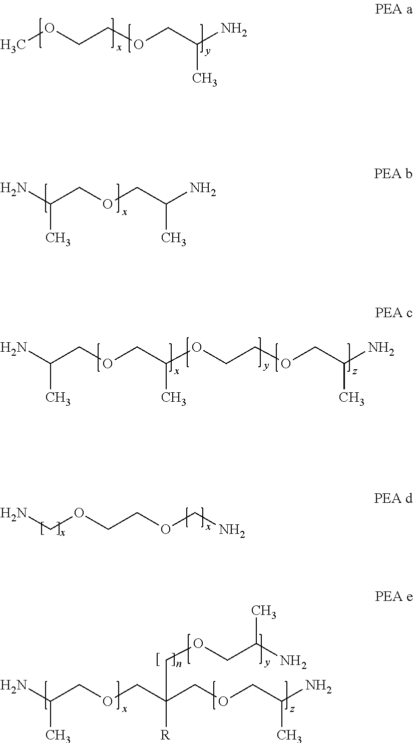

In some embodiments, organic acids comprising at least one primary group are selected from 2-aminoethanesulfonic acid (taurine) and 2-aminopropanesulfonic acid (homotaurin).

The diol or triol, which can be used in a mixture together with the organic amine (b), can have a relatively low-molecular-weight or a relatively high-molecular-weight. Non-limiting examples of triols are glycerol, 1,1,1-(trihydroxymethylene)methane, 1,1,1-(trihydroxymethylene)ethane and 1,1,1-(trihydroxymethylene)propane.

In some embodiments, relatively low-molecular-weight diols are employed, e.g., wherein the molecular weight of the diol is less than 500 g/mol (e.g., less than 400 g/mol, less than 300 g/mol, or less than 200 g/mol). Non-limiting examples of such diols include 1,2-ethanediol, 1,2-propanediol, 1,3-propanediol, 1,2-butanediol, 1,3-butanediol, 1,4-butanediol, 1,4-but-2-enediol, 1,4-but-2-ynediol, 1,5-pentanediol and positional isomers thereof, 1,6-hexanediol, 1,8-octanediol, 1,4-bishydroxymethylcyclohexane, 2,2-bis-(4-hydroxycyclohexyl)propane, 2-methyl-1,3-propanediol, diethylene glycol, triethylene glycol, tetraethylene glycol and 2,2-dimethylpropane-1,3-diol (neopentyl glycol). It should be appreciated that molecular weight outside of these ranges are also possible.

In other embodiments, diols having a molecular weight greater than 500 g/mol can be used, e.g., up to 10,000 g/mol.

In general, the diol may have any suitable molecular weight (e.g., number average molecular weight, Mₙ). In some embodiments, the average molecular weight (e.g., number average molecular weight, Mₙ) of the diol may be greater than or equal to about 500 g/mol, greater than or equal to about 700 g/mol, greater than or equal to about 1000 g/mol, greater than or equal to about 1,500 g/mol, greater than or equal to about 2,000 g/mol, greater than or equal to about 5,000 g/mol, or greater than or equal to about 7,500 g/mol. In certain embodiments, the average molecular weight (e.g., number average molecular weight, MO of the diol may be less than or equal to about 10,000 g/mol, less than or equal to about 7,500 g/mol, less than or equal to about 5,000 g/mol, less than or equal to about 2,000 g/mol, less than or equal to about 1,500 g/mol, less than or equal to about 1,000 g/mol, or any other appropriate molecular weight. Combinations of the above are possible (e.g. a molecular weight of about 500 g/mol to about 10,000 g/mol, or about 1,000 g/mol to about 5,000 g/mol).

Combinations of the above referenced ranges are also possible. Other ranges are also possible.

In certain embodiments, the diol is a polymeric diol. In some embodiments, as polymeric diols, dihydric or polyhydric polyester polyols and polyether polyols may be employed. As polyether polyols, polyether diols may be used and are obtainable, for example, by boron trifluoride-catalyzed linking of ethylene oxide, propylene oxide, butylene oxide, tetrahydrofuran, styrene oxide or epichlorohydrin with itself or among one another or by addition of these compounds, individually or in a mixture, to starter components having reactive hydrogen atoms such as water, polyhydric alcohols, or amines such as 1,2-ethanediol, propane-(1,3)-diol, 1,2- or 2,2-bis-(4-hydroxyphenyl)propane or aniline. In addition, polyether-1,3-diols, for example trimethylol propane alkoxylated at an OH group, the alkylene oxide chain of which is closed with an alkyl radical comprising 1 to 18 carbon atoms, may be employed as polymeric diols. In one particular set of embodiments, polymeric diols may include polyethylene glycol, polypropylene glycol, and/or polytetrahydrofuran (poly-THF).

Non-limiting examples of polyether polyols include polyethylene glycol (e.g., having an average molecular weight (Mₙ) in the range from 200 to 9000 g/mol, or from 500 to 6000 g/mol), poly-1,2-propylene glycol (e.g., having an average molecular weight (Mₙ) in the range from 250 to 6000, or from 600 to 4000 g/mol), poly-1,3-propane diol (e.g., having an average molecular weight (Mₙ) in the range from 250 to 6000, or from 600 to 4000 g/mol), or poly-THF (e.g., having an average molecular weight (Mₙ) in the range from 250 to 5000, or from 500 to 3000 g/mol, or from 750 to 2500 g/mol). It should be appreciated that molecular weight outside of these ranges are also possible.

In some embodiments, the polymeric diol is a polyester polyol (polyester diol) or a polycarbonate diol. As polycarbonate diols, in particular aliphatic polycarbonate diols may be included, for example 1,4-butanediol polycarbonate and 1,6-hexanediol polycarbonate. As polyester diols, those which may be produced by polycondensation of at least one primary diol, for example, at least one primary aliphatic diol (e.g., ethylene glycol, 1,4-butanediol, 1,6-hexanediol, neopentyl glycol, 1,4-dihydroxymethylcyclohexane (e.g., as mixture of isomers), or mixtures of at least two of the abovementioned diols), may be included. In some embodiments, at least one, (e.g., at least two) dicarboxylic acids or anhydrides thereof may be included. Non-limiting examples of dicarboxylic acids include aliphatic dicarboxylic acids such as adipic acid, glutaric acid, succinic acid, phthalic acid and isophthalic acid.

In some embodiments, polyester diols and polycarbonate diols are selected from those having an average molecular weight (Mₙ) in the range from 500 to 9000 g/mol, or from 500 to 6000 g/mol. In certain embodiments, the diol is polytetrahydrofuran, for example, having an average molecular weight Mₙ in the range from 250 to 2000 g/mol. It should be appreciated that molecular weight outside of these ranges are also possible.

In certain embodiments, in a mixture of at least one organic amine comprising at least one primary or secondary amino group and at least one diol or triol, the molar ratio of the sum of all amino groups to the sum of all hydroxyl groups of the diol or triol can be varied in a wide range. For example, in some cases, the molar ratio of the sum of all amino groups to the sum of all hydroxyl groups of the diols and triols may be in the range from 0.001 to 1000 (e.g., from 0.01 to 100, or from 0.1-10).

In some embodiments, polyimide (a) and organic amine (b) or the mixture of organic amine (b) and at least one diol or triol, are used in quantitative ratios such that the molar ratio of the sum of all amino groups and all hydroxyl groups to the sum of NCO groups and COOH groups of polyimide (a) is 1:10 to 10:1 (e.g., from 1:5 to 5:1, or from 1:3 to 3:1).

In some embodiments, polymeric material (aa) has an acid value in the range from zero to 200 mg of KOH/g, determined according to the standard DIN 53402 (1990-09).

In certain embodiments, polymeric material (aa), (e.g., the reaction product from polyimide (a) and at least one organic amine (b)) has a quotient M_{w}/Mₙ in the range from 1.2 to 10, or from 1.5 to 5, or from 1.8 to 4. The quotient M_{w}/Mₙ may be determined by gel-permeation chromatography.

In some embodiments, the molecular weight (e.g., M_{w}) of polymeric material (aa) may be greater than or equal to about 1000 g/mol, greater than or equal to about 5000 g/mol, greater than or equal to about 10,000 g/mol, greater than or equal to about 15,000 g/mol, greater than or equal to about 20,000 g/mol, greater than or equal to about 30,000 g/mol, greater than or equal to about 50,000 g/mol, greater than or equal to about 100,000 g/mol, greater than or equal to about 200,000 g/mol. Further, the molecular weight of polymeric material (aa) may be less than or equal to about 300,000 g/mol, less than or equal to about 200,000 g/mol, less than or equal to about 100,000 g/mol, less than or equal to about 50,000 g/mol, less than or equal to about 30,000 g/mol, less than or equal to about 20,000 g/mol, less than or equal to about 15,000 g/mol, less than or equal to about 10,000 g/mol, or less than or equal to about 5000 g/mol. Combinations of the above are possible (e.g., a molecular weight of greater than or equal to about 500 g/mol and less than or equal to about 200,000 g/mol, or greater than or equal to about 2000 g/mol and less than or equal to about 30,000 g/mol). Other combinations are also possible. Other ranges are also possible.

In some embodiments, polyisocyanate (bb) can be selected from any polyisocyanates that have on average at least two isocyanate groups (e.g., at least 3, at least 4, at least 5) per molecule which can be present capped or free. Non-limiting examples of polyisocyanates (bb) include hexamethylene diisocyanate, isophorone diisocyanate, toluylene diisocyanate, 4,4′-diphenylmethane diisocyanate, 2,4′-diphenylmethane diisocyanate, and mixtures of at least two of the abovementioned polyisocyanates. For example, mixtures of 4,4′-diphenylmethane diisocyanate and 2,4′-diphenylmethane diisocyanate, or mixtures of 2,4-toluylene diisocyanate and 2,6-toluylene diisocyanate, may be used.

In some embodiments, polyisocyanate (bb) may include oligomeric hexamethylene diisocyanate, oligomeric tetramethylene diisocyanate, oligomeric isophorone diisocyanate, oligomeric diphenylmethane diisocyanate, trimeric toluylene diisocyanate or mixtures of at least two of the abovementioned polyisocyanates (bb). For example, what is termed trimeric hexamethylene diisocyanate may not the pure trimeric diisocyanate, but the polyisocyanate may have a mean functionality of 3.6 to 4 NCO groups per molecule. The same applies to oligomeric tetramethylene diisocyanate and oligomeric isophorone diisocyanate. In some embodiments, polyisocyanate (bb) is a mixture of at least one diisocyanate and at least one triisocyanate or a polyisocyanate having at least 4 isocyanate groups per molecule. In some embodiments, polyisocyanate (bb) has on average exactly 2.0 isocyanate groups per molecule. In certain embodiments, polyisocyanate (bb) has on average up to 8, or up to 6, isocyanate groups per molecule. In some cases, polyisocyanate (bb) may have on average at least 2.2, or at least 2.5, or at least 3.0, isocyanate groups per molecule.

In some embodiments, polyisocyanate (bb) is selected from oligomeric hexamethylene diisocyanate, oligomeric isophorone diisocyanate, oligomeric diphenylmethane diisocyanate, or mixtures of the abovementioned polyisocyanates.

Polyisocyanate (bb), in addition to urethane groups, can also have one or more other functional groups selected from allophanate, biuret, carbodiimide, amide, ester, ether, uretonimine, uretdione, isocyanurate and oxazolidine groups.

In some embodiments, polyisocyanate (a1) and polyisocyanate (bb) of the cross-linked polymeric material are equal. In an alternative embodiments, polyisocyanate (a1) and polyisocyanate (bb) of the cross-linked polymeric material are different.

Non-limiting examples of synthesis methods for making crosslinked polymeric materials described herein are provided below. In some embodiments, the synthesis method for making the crosslinked polymeric material comprises:

forming polymeric material (aa) by reacting with one another
(α) polyimide (a) formed by condensation of at least one polyisocyanate (a1) having on average at least two isocyanate groups per molecule with at least one polycarboxylic acid (a2) having at least 3 COOH groups per molecule or anhydride (a2) thereof, and
(β) at least one organic amine (b), which comprises at least one primary or secondary amino group, or a mixture of at least one organic amine comprising at least one primary or secondary amino group and at least one diol or triol, and
(γ) cross-linking the polymeric material (aa), which was prepared in reaction step (β), by mixing it with at least one polyisocyanate (bb), which has on average at least two isocyanate groups per molecule.

In certain embodiments, the product of reaction step (α), the polyimide (a), can be either isolated or it can be used directly without isolation in the following reaction step (β) in order to prepare polymeric material (aa). In some cases, for the preparation of the cross-linked polymeric material in reaction step (γ), the polymeric material (aa) can be either isolated or it can be used without isolation. In some embodiments, reaction steps (α) and (β) are carried out in a single step and the purification and isolation of polyimide (a) are omitted, but the polymeric material (aa) is isolated before it is reacted with polyisocyanate (bb) in reaction step (γ).

In some embodiments, the condensation of at least one polyisocyanate (a1) having on average at least two isocyanate groups per molecule with at least one polycarboxylic acid (a2) in the form of its anhydride is done without addition of a catalyst, wherein water may not be considered as a catalyst.

For carrying out the synthesis method for making polyimide (a), polyisocyanate (a1) and polycarboxylic acid (a2) or anhydride (a2) can be used in a quantitative ratio such that the molar fraction of NCO groups to COOH groups is in the range from 1:3 to 3:1, or from 1:2 to 2:1. In this case, one anhydride group of the formula CO—O—CO counts as two COOH groups.

In some embodiments, synthesis methods for making polyimide (a) can be carried out at temperatures in the range from 25 to 200° C., or from 50 to 140° C., or from 50 to 100° C.

In some embodiments, synthesis methods for making polyimide (a) can be carried out at atmospheric pressure. However, the synthesis is also possible under pressure, for example at pressures in the range from 1.1 to 10 bar.

The reaction for making polyimide (a) can be carried out without or with a solvent. In embodiments in which a solvent is used, the solvent may include, for example, N-methylpyrrolidone, N-ethylpyrrolidone, dimethylformamide, dimethylacetamide, dimethyl sulfoxide, dimethyl sulphones, xylene, phenol, cresol, cyclic ethers such as, for example, tetrahydrofurane or 1,4-dioxane, cyclic acetals such as 1,3-dioxolane or 1,3-dioxane, ketones such as, for example, acetone, methyl ethyl ketone (MEK), methyl isobutyl ketone (MIBK), acetophenone, in addition mono- and dichlorobenzene, ethylene glycol monoethyl ether acetate and mixtures of two or more of the abovementioned mixtures. The solvent or solvents can be present during the entire synthesis time or only during part of the synthesis.

In some embodiments, synthesis methods for making polyimide (a) can be carried out for a time period of 10 minutes to 24 hours. In certain embodiments, synthesis methods for making polyimide (a) can be carried out under inert gas, or under argon, or under nitrogen.

The reaction conditions in reaction step (β) may be similar to those of reaction step (a) with respect to solvents, temperature, pressure and reaction time. In some embodiments, polymeric material (aa) is isolated after finishing reaction step (β), for example, by removing used solvents.

In some embodiments, a cross-linked polymeric material is synthesized in reaction step (γ) by reacting the polymeric material (aa) with at least one polyisocyanate (bb), as described above. In certain embodiments, polyisocyanate (a1) and polyisocyanate (bb) of a specific cross-linked polymeric material are the same compound. In some cases, polyisocyanate (a1) and polyisocyanate (bb) of a specific cross-linked polymeric material are different compounds.

In some embodiments, the reaction of polymeric material (aa) and polyisocyanate (bb) may be carried out without or with a solvent. In embodiments in which a solvent is used, examples of such solvents include NMP,THF, 1,3-dioxolane, 1,4-dioxane, and mixtures thereof. In certain embodiments, the reaction of polymeric material (aa) with polyisocyanate (bb) may be carried out without or with a catalyst. In some embodiments, the reaction or polymeric material (aa) with polyisocyanate (bb) may be carried out at a temperature in the range of, e.g., from 10 to 90° C., or from 20 to 30° C. In certain embodiments, the reaction of polymeric material (aa) with polyisocyanate (bb) may be carried out at atmospheric pressure.

In certain embodiments, a cross-linked polymeric material described herein may be formed into an article (e.g., a substantially planar article) using any suitable method. For example, the crosslinked polymeric material may be shaped by mechanical means such as cutting, milling or cold pressure welding. In some embodiments, the crosslinked polymeric material is cast as a mixture comprising polymeric material (aa) and polyisocyanate (bb) in a desired form and/or shape, which is retained after the cross-linking reaction. In some cases, the crosslinked polymeric material is casted as a thin film from a solution comprising polymeric material (aa) and polyisocyanate (bb).

One or more polymer layers (e.g., comprising a crosslinked polymeric material), as described herein, may have a mean peak to valley roughness (R_{z}) of less than or equal to about 2 μm, less than or equal to about 1.5 μm, less than or equal to about 1 μm, less than or equal to about 0.9 μm, less than or equal to about 0.8 μm, less than or equal to about 0.7 μm, less than or equal to about 0.6 μm, less than or equal to about 0.5 μm, or any other appropriate roughness. In some embodiments, the one or more polymer layers (e.g., comprising a crosslinked polymeric material) has an R_{z} of greater than or equal to about 50 nm, greater than or equal to about 0.1 μm, greater than or equal to about 0.2 μm, greater than or equal to about 0.4 μm, greater than or equal to about 0.6 μm, greater than or equal to about 0.8 μm, greater than or equal to about 1 μm, or any other appropriate roughness. Combinations of the above-noted ranges are possible (e.g., an R_{z} of greater than or equal to about 0.1 μm and less than or equal to about 1 μm). Other ranges are also possible.

The surface roughness (e.g., the mean peak to valley roughness (Rz)) may be calculated, for example, by imaging the surface with a non-contact 3D optical microscope (e.g., an optical profiler). Briefly, an image may be acquired at a magnification between about 5× and about 110× (e.g., an area of between about 50 microns×50 microns and about 1.2 mm×1.2 mm) depending on the overall surface roughness. Those skilled in the art would be capable of selecting an appropriate magnification for imaging the sample. The mean peak to valley roughness can be determined by taking an average of the height difference between the highest peaks and the lowest valleys for a given sample size (e.g., averaging the height difference between the five highest peaks and the five lowest valleys across the imaged area of the sample) at several different locations on the sample (e.g., images acquired at five different areas on the sample).

In one particular embodiment, an electrode structure as described herein includes at least one polymer layer that has a surface facing towards an electrode (e.g., an electroactive layer), the polymer layer having a mean peak to valley roughness of between 0.1 μm and 1 μm.

One or more polymer layers (e.g., comprising a crosslinked polymeric material described herein) may each (independently) have a thickness greater than or equal to about 0.1 μm, greater than or equal to about 0.2 μm, greater than or equal to about 0.3 μm, greater than or equal to about 0.4 μm, greater than or equal to about 0.5 μm, greater than or equal to about 0.6 μm, greater than or equal to about 0.7 μm, greater than or equal to about 0.8 μm, greater than or equal to about 0.9 μm, greater than or equal to about 1 μm, greater than or equal to about 2 μm, greater than or equal to about 3 μm, greater than or equal to about 4 μm, greater than or equal to about 5 μm, greater than or equal to about 10 μm, greater than or equal to about 20 μm, or any other appropriate thickness. In some embodiments, the one or more polymer layers (e.g., comprising a crosslinked polymeric material described herein) may each independently have a thickness less than or equal to about 100 μm, less than or equal to about 50 μm, less than or equal to about 20 μm, less than or equal to about 10 μm, less than or equal to about 5 μm, less than or equal to about 4 μm, less than or equal to about 3 μm, less than or equal to about 2 μm, less than or equal to about 1 μm, or any other appropriate thickness. Combinations of the above noted ranges are possible (e.g., a thickness greater than or equal to about 1 μm and less than or equal to about 20 μm). Other ranges are also possible.

Having generally described the types of polymers in the compositions described herein, the incorporation of the polymers into an electrochemical cell will now be described. While many embodiments described herein relate to lithium/sulfur electrochemical cells, it is to be understood that any analogous alkali metal/sulfur electrochemical cells (including alkali metal anodes) can be used. As noted above and as described in more detail herein, in some embodiments, the crosslinked polymeric material is incorporated into a lithium-sulfur electrochemical cell as a protective layer for an electrode, a polymer gel electrolyte, a release layer and/or a separator. In certain embodiments, one or more of the polymeric materials disclosed herein serve as a protective layer for an anode comprising lithium.

As described herein, in some embodiments an article such as an electrode, electrode precursor, or electrochemical cell includes a protective layer and/or protective structure (e.g., a multi-layered structure) that incorporates one or more of the herein disclosed polymers to separate an electroactive material from an electrolyte to be used with the electrode or electrochemical cell. The separation of an electroactive layer from the electrolyte of an electrochemical cell can be desirable for a variety of reasons, including (e.g., for lithium batteries) the prevention of dendrite formation during recharging, preventing reaction of lithium with the electrolyte or components in the electrolyte (e.g., solvents, salts and cathode discharge products), increasing cycle life, and/or improving safety (e.g., preventing thermal runaway). Reaction of an electroactive lithium layer with the electrolyte may result in the formation of resistive film barriers on the anode, which can increase the internal resistance of the battery and lower the amount of current capable of being supplied by the battery at the rated voltage.

In some embodiments, a protective layer and/or protective structure that incorporates one or more of the polymers described herein is substantially impermeable to the electrolyte. In certain embodiments, at least a portion of the protective layer and/or protective structure is unswollen in the presence of the electrolyte. However, in other embodiments, at least a portion of the protective layer and/or protective structure can be swollen in the presence of the electrolyte. The protective layer and/or protective structure may, in some cases, be substantially non-porous. In certain embodiments, the protective layer and/or protective structure may have an average pore size of less than or equal to 10 microns, less than or equal to 5 microns, less than or equal to 2 microns, less than or equal to 1 micron, less than or equal to 0.5 microns, less than or equal to 0.1 microns, less than or equal to 50 nm, less than or equal to 20 nm, less than or equal to 10 nm, or less than or equal to 5 nm. Generally, the protective layer is formed associated with an electrode. For instance, the protective layer may be positioned directly adjacent the electrode, or adjacent the electrode via an intervening layer (e.g., another protective layer).

In others embodiments, one or more of the herein disclosed polymers may serve as a protective layer for an electrode (e.g., the cathode, the anode). For example, one or more of the herein disclosed polymers may act as a protective layer protecting cell from thermal runaway and/or delaying thermal runaway to an elevated temperature. The term “thermal runaway” is understood by those of ordinary skill in the art, and refers to a situation in which the electrochemical cell cannot dissipate the heat generated during charge and discharge sufficiently fast to prevent uncontrolled temperature increases within the cell. Often, a positive feedback loop can be created during thermal runaway (e.g., the electrochemical reaction produces heat, which increases the rate of the electrochemical reaction, which leads to further production of heat), which can cause electrochemical cells to catch fire. For example, thermal runaway may be caused, in some cases, by a self-accelerating reaction between lithium (e.g., metallic lithium) and sulfur and/or polysulfide at elevated temperatures.

In some embodiments, an electrochemical cell can include a polymer described herein (e.g., as a protective layer). In some embodiments, the electrochemical cells described herein can be cycled at relatively high temperatures without experiencing thermal runaway. Not wishing to be bound by any particular theory, a polymer described herein (e.g., used as a protective layer positioned between the electrolyte and an electroactive layer) may slow down the reaction between the electroactive material such as lithium (e.g., metallic lithium) and the cathode active material (e.g., sulphur such as elemental sulfur) in the electrochemical cell, inhibiting (e.g., preventing) thermal runaway from taking place. Also, the polymer within the electrolyte may serve as a physical barrier between the lithium and the cathode active material, inhibiting (e.g., preventing) thermal runaway from taking place. In some such embodiments, the protective layer may be directly adjacent the anode (e.g., to prevent and/or delay thermal runaway at the anode).

In certain embodiments, one or more of the herein disclosed polymers may reduce the rate of such a reaction and/or change the balance between heat generation and heat dissipation in the electrochemical cell. For example, in some cases, one or more of the herein disclosed polymers may prevent thermal runaway (e.g., by preventing contact between the polysulfide and the lithium) at certain temperatures (e.g., the operating temperatures of an electrochemical cell). In certain embodiments, one or more of the herein disclosed polymers may delay thermal runaway to occur at a more elevated temperature (e.g., between about 180° C. and about 220° C., or up to another temperature described below) as compared to thermal runaway that occurs in an electrochemical cell without such a protective layer (e.g., at a temperature between about 130° C. and about 140° C., or up to another temperature described below). This may be due to the fact that many of the polymers described herein are stable to extremely high temperatures and/or do not exhibit a glass transition temperature. In some embodiments, the polymers aid in operation of the electrochemical cell (e.g., continuously charged and discharged) at a temperature of up to about 130° C., up to about 150° C., up to about 170° C., up to about 190° C., up to 210° C., up to about 230° C., up to about 250° C., up to about 270° C., up to about 290° C., up to about 300° C., up to about 320° C., up to about 340° C., up to about 360° C., or up to about 370° C. (e.g., as measured at the external surface of the electrochemical cell) without the electrochemical cell experiencing thermal runaway. In some embodiments, the polymers described herein have a decomposition temperature of greater than or equal to about 200° C., greater than or equal to about 250° C., greater than or equal to about 300° C., greater than or equal to about 350° C., or greater than or equal to about 370° C. (e.g., less than or equal to about 700° C.). Other ranges are also possible.

In some embodiments, the electrochemical cell can be operated at any of the temperatures outlined above without igniting. In some embodiments, the electrochemical cells described herein can be operated at relatively high temperatures (e.g., any of the temperatures outlined above) without experiencing thermal runaway and without employing an auxiliary cooling mechanism (e.g., a heat exchanger external to the electrochemical cell, active fluid cooling external to the electrochemical cell, and the like).

The presence of thermal runaway in an electrochemical cell can be identified by one of ordinary skill in the art. In some embodiments, thermal runaway can be identified by one or more of melted components, diffusion and/or intermixing between components or materials, the presence of certain side products, and/or ignition of the cell.

The polymer may, in some cases, compensate for the roughness of the electrode (e.g., the cathode, the anode) if the electrode is not smooth.

While a variety of techniques and components for protection of lithium and other alkali metal anodes are known, these protective coatings present particular challenges, especially in rechargeable batteries. Since lithium batteries function by removal and re-plating of lithium from a lithium anode in each discharge/charge cycle, lithium ions must be able to pass through any protective coating. The coating must also be able to withstand morphological changes as material is removed and re-plated at the anode. The effectiveness of the protective structure in protecting an electroactive layer may also depend, at least in part, on how well the protective structure is integrated with the electroactive layer, the presence of any defects in the structure, and/or the smoothness of the layer(s) of the protective structure. Many single thin film materials, when deposited on the surface of an electroactive lithium layer, do not have all of the necessary properties of passing Li ions, forcing a substantial amount of the Li surface to participate in current conduction, protecting the metallic Li anode against certain species (e.g., liquid electrolyte and/or polysulfides generated from a sulfur-based cathode) migrating from the cathode, and impeding high current density-induced surface damage.

The inventors of the present application have developed solutions to address the problems described herein through several embodiments of the invention, including, in one set of embodiments, the combination of an electroactive layer and a protective structure including a layer formed at least in part of a polymer described herein. In another set of embodiments, an electroactive layer may include a protective structure in combination with a polymer gel layer formed from one or more the polymers disclosed herein positioned adjacent the protective structure.

In another set of embodiments, solutions to the problems described herein involve the use of an article including an anode comprising lithium, or any other appropriate electroactive material, and a multi-layered structure positioned between the anode and an electrolyte of the cell. The multi-layered structure may serve as a protective layer or structure as described herein. In some embodiments, the multi-layered structure may include, for example, at least a first ion conductive material layer and at least a first polymeric layer formed from one or more of the polymers disclosed herein and positioned adjacent the ion conductive material. In this embodiment, the multi-layered structure can optionally include several sets of alternating ion conductive material layers and polymeric layers. The multi-layered structures can allow passage of lithium ions, while limiting passage of certain chemical species that may adversely affect the anode (e.g., species in the electrolyte). This arrangement can provide significant advantage, as polymers can be selected that impart flexibility to the system where it can be needed most, namely, at the surface of the electrode where morphological changes occur upon charge and discharge.

In some embodiments, ionic compounds (i.e., salts) may be included in the disclosed polymer compositions. For example, in some embodiments, lithium salts may be advantageously included in a polymer layer in relatively high amounts. Inclusion of the lithium and/or other salts may increase the ion conductivity of the polymer. Increases in the ion conductivity of the polymer may enable enhanced ion diffusion between associated anodes and cathodes within an electrochemical cell. Therefore, inclusion of the salts may enable increases in specific power available from an electrochemical cell and/or extend the useful life of an electrochemical cell due to the increased diffusion rate of the ion species there through. In another embodiment, one or more of the polymers described herein may be deposited between the active surface of an electroactive material and an electrolyte to be used in the electrochemical cell. Other configurations of polymers and polymer layers are also provided herein.

In some embodiments, certain methods of synthesis are employed for forming a protective layer comprising a polymer composition described herein. The method may involve forming the protective layer adjacent or on a portion of an anode comprising lithium.

In one particular embodiment, a method involves providing an anode comprising lithium, and forming a protective layer comprising a polymer adjacent the anode. The step of forming the protective layer comprising the polymer may involve crosslinking a polymeric material formed by reaction of: (aa) a polymeric material obtainable by reaction of (a) at least one polyimide selected from condensation products of (a1) at least one polyisocyanate having on average at least two isocyanate groups per molecule and, (a2) at least one polycarboxylic acid having at least 3 COOH groups per molecule or anhydride thereof, and (b) at least one organic amine comprising at least one primary or secondary amino group, or a mixture of at least one organic amine comprising at least one primary or secondary amino group and at least one diol or triol, and (bb) at least one polyisocyanate having on average at least two isocyanate groups per molecule. As described herein, the protective layer comprising the polymer may be directly adjacent the anode, or an intervening layer (e.g., another protective layer) may be present between the anode and the protective layer comprising the polymer. In some embodiments, the protective layer comprising the polymer may be part of a multi-layered protective structure.

In another particular embodiment, a method comprises exposing an anode comprising lithium to a solution comprising a crosslinked polymeric material formed by reaction of (aa) a polymeric material obtainable by reaction of (a) at least one polyimide selected from condensation products of (a1) at least one polyisocyanate having on average at least two isocyanate groups per molecule and, (a2) at least one polycarboxylic acid having at least 3 COOH groups per molecule or anhydride thereof, and (b) at least one organic amine comprising at least one primary or secondary amino group, or a mixture of at least one organic amine comprising at least one primary or secondary amino group and at least one diol or triol, and (bb) at least one polyisocyanate having on average at least two isocyanate groups per molecule. The protective layer comprising the polymer composition may be formed by crosslinking the polymeric material (aa) with (bb) at least one polyisocyanate having on average at least two isocyanate groups per molecule. Each of (a1) the at least one polyisocyanate having on average at least two isocyanate groups per molecule, (a2) the at least one polycarboxylic acid having at least 3 COOH groups per molecule or an anhydride or ester thereof, and (b) the at least one organic amine comprising at least one primary or secondary amino group, or a mixture of at least one organic amine comprising at least one primary or secondary amino group and at least one diol or triol, may be as described herein.

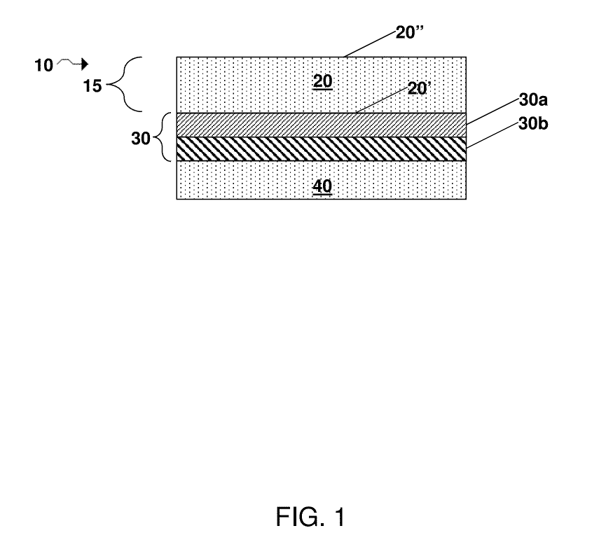

Turning now to the figures, FIG. 1 shows a specific example of an article that can be used in an electrochemical cell according to one set of embodiments. As shown in this exemplary embodiment, article 10 includes an electrode 15 (e.g., an anode or a cathode) comprising an electroactive layer 20. The electroactive layer comprises an electroactive material (e.g., lithium metal). In certain embodiments, the electroactive layer may be covered by a protective structure 30, which can include, for example, an optional ion conductive layer 30a (e.g., a ceramic) disposed on an active surface 20′ of the electroactive layer 20 and a polymer layer 30b formed from her comprising one or more of the polymers disclosed herein and optionally disposed on the ion conductive layer 30a. In embodiments in which ion conductive layer 30a is not present, polymer layer 30b may be positioned directly on the electroactive layer. In other embodiments, an ion conductive layer may be positioned adjacent a polymer layer, e.g., between the polymer layer and an electrolyte 40. The protective structure may, in some embodiments, act as an effective barrier to protect the electroactive material from reaction with certain species in the electrolyte. In some embodiments, article 10 includes an electrolyte 40, which may be positioned adjacent the protective structure, e.g., on a side opposite the electroactive layer. The electrolyte can function as a medium for the storage and transport of ions. In some instances, electrolyte 40 may comprise a gel polymer electrolyte formed from the compositions disclosed herein. In some embodiments, a current collector (not shown) may be positioned adjacent the electroactive layer 20 on surface 20″.

A layer referred to as being “covered by,” “on,” or “adjacent” another layer means that it can be directly covered by, on, or adjacent the layer, or an intervening layer may also be present. For example, a polymer layer described herein (e.g., a polymer layer used as a protective layer) that is adjacent an anode or cathode may be directly adjacent the anode or cathode, or an intervening layer (e.g., another protective layer) may be positioned between the anode and the polymer layer. A layer that is “directly adjacent,” “directly on,” or “in contact with,” another layer means that no intervening layer is present. It should also be understood that when a layer is referred to as being “covered by,” “on,” or “adjacent” another layer, it may be covered by, on or adjacent the entire layer or a part of the layer.

It should be appreciated that FIG. 1 is an exemplary illustration and that in some embodiments, not all components shown in the figure need be present. In yet other embodiments, additional components not shown in the figure may be present in the articles described herein. In another example, although FIG. 1 shows an ion conductive layer 30a disposed directly on the surface of the electroactive layer, in other embodiments, polymer layer 30b may be disposed directly on the surface of the electroactive layer as described herein. Other configurations are also possible.

As described herein, it may be desirable to determine if a polymer has advantageous properties as compared to other materials for particular electrochemical systems. Therefore, simple screening tests can be employed to help select between candidate materials. One simple screening test includes positioning a layer of the resulting polymer of the desired chemistry in an electrochemical cell, e.g., as a protective layer (or a polymer gel electrolyte, a separator, or a release layer) in a cell. The electrochemical cell may then undergo multiple discharge/charge cycles, and the electrochemical cell may be observed for whether inhibitory or other destructive behavior occurs (e.g., nucleophilic attack of polymer bonds by a polysulfide) compared to that in a control system. If inhibitory or other destructive behavior is observed during cycling of the cell, as compared to the control system, it may be indicative of degradation mechanisms of the polymer, within the assembled electrochemical cell. Using the same electrochemical cell it is also possible to evaluate the electrical conductivity and ion conductivity of the polymer using methods known to one of ordinary skill in the art. The measured values may be compared to select between candidate materials and may be used for comparison with the baseline material in the control.

A simple test may involve testing the ability of the polymer to swell or to not swell in the presence of an electrolyte or solvent to be used in an electrochemical cell (including any salts or additives present). For example, in some cases, pieces of the polymer may be weighed and then placed in a solvent or an electrolyte to be used in an electrochemical cell for any suitable amount of time (e.g., 24 hours), and the percent difference in weight (or volume) of the polymer before and after the addition of a solvent or an electrolyte may determine the amount of swelling of the polymer in the presence of the electrolyte or the solvent.

In some embodiments, the weight (or volume) percent difference of the polymer after exposure to a solvent or electrolyte may be greater than or equal to about 10%, greater than or equal to about 50%, greater than or equal to about 100%, greater than or equal to about 200%, greater than or equal to about 300%, greater than or equal to about 400%, greater than or equal to about 500%, greater than or equal to about 800%, greater than or equal to about 1000%, or greater than or equal to about 1100% with respect to the weight (or volume) of the polymer before exposure to the solvent or electrolyte. In certain embodiments, the weight (or volume) percent difference of the polymer after exposure to a solvent or electrolyte may be less than or equal to about 1200%, less than or equal to about 1100%, less than or equal to about 1000%, less than or equal to about 800%, less than equal to about 500%, or less than or equal to about 300% with respect to the weight (or volume) of the polymer before exposure to the solvent or electrolyte. Combinations of the above-referenced ranges are also possible (e.g., between about 500% and about 1100%). Other weight percent differences are also possible. In some embodiments, the electrolyte is 8 wt % lithium bis trifluoromethanesulfonimide and 4 wt % LiNO₂ in a 1:1 mixture by weight of 1,2-dimethoxyethane and 1,3-dioxolane. In some embodiments, the total salt concentration in the electrolyte may be between about 8 and about 24 wt %. Other concentrations are also possible.

Another simple screen test involves determining the stability (i.e., integrity) of a polymer to polysulfides. Briefly, the polymer may be exposed to a polysulfide solution/mixture for any suitable amount of time (e.g., 72 hours) and the percent weight loss of the polymer after exposure to the polysulfide solution may be determined by calculating the difference in weight of the polymer before and after the exposure. For example, in some embodiments, the percent weight loss of the polymer after exposure to the polysulfide solution may be less than or equal to about 15 wt %, less than or equal to about 10 wt %, less than or equal to about 5 wt %, less than or equal to about 2 wt %, less than or equal to about 1 wt %, or less than or equal to about 0.5 wt %. In certain embodiments, the percent weight loss of the polymer after exposure to the polysulfide solution may be greater than about 0.1 wt %, greater than about 0.5 wt %, greater than about 1 wt %, greater than about 2 wt %, greater than about 5 wt %, or greater than about 10 wt %. Combinations of the above-referenced ranges are also possible (e.g., between about 0.1 wt % and about 5 wt %).

Another simple screening test involves determining the ability of a polymer to prevent and/or delay thermal runaway. Briefly, an electrochemical cell (e.g., comprising a polymer) may be operated (e.g., charged/discharged) and the presence of thermal runaway may be determined by measuring the temperature (e.g., exterior temperature) of the electrochemical cell. For example, in some embodiments, thermal runaway may be determined to have occurred if the temperature of the electrochemical cell reaches greater than about 300° C. (e.g., greater than about 400° C.) during operation (e.g., during charging/discharging). In some cases, thermal runaway may result in fire, rupturing of the electrochemical cell, release of electrolyte and/or solvent vapors, and/or melting of a separator layer. In some cases, thermal runaway may be determined by measuring the voltage of the electrochemical cell during operation (e.g., charging/discharging) and observing if loses of voltage occur (e.g., as a result of thermal runaway causing electrical shorting through the separator layer).

Another simple screening test to determine if a polymer has suitable mechanical strength may be accomplished using any suitable mechanical testing methods including, but not limited to, durometer testing, yield strength testing using a tensile testing machine, and other appropriate testing methods. In one set of embodiments, the polymer has a yield strength that is greater than or equal to the yield strength of the electroactive material (e.g., metallic lithium). For example, the yield strength of the polymer may be greater than approximately 2 times, 3 times, or 4 times the yield strength of electroactive material (e.g., metallic lithium). In some embodiments, the yield strength of the polymer is less than or equal to 10 times, 8 times, 6 times, 5 times, 4 times, or 3 times the yield strength of electroactive material (e.g., metallic lithium). Combinations of the above-referenced ranges are also possible. In one specific embodiment, the yield strength of the polymer is greater than approximately 10 kg/cm² (i.e., approximately 980 kPa). Other yield strengths greater than or less than the above limits are also possible. Other simple tests to characterize the polymers may also be conducted by those of ordinary skill in the art.

In some embodiments, the polymeric materials are stable to an applied pressure of at least 10 kg/cm², at least 20 kg/cm², or at least 30 kg/cm² in a swollen state. In some embodiments, the stability may be determined in the electrolyte solvent to be used with the electrochemical cell. In some embodiments, the electrolyte is 8 wt % lithium bis trifluoromethanesulfonimide and 4 wt % LiNO₂ in a 1:1 mixture by weight of 1,2-dimethoxyethane and 1,3-dioxolane. In some embodiments, the total salt concentration in the electrolyte may be between about 8 and about 24 wt %. Other concentrations are also possible.

The polymer layer formed by a composition described herein may have any suitable thickness, as described above. In embodiments wherein the polymer is to be employed as a separator, the thickness may be, for example, between about 1 micron and about 20 microns. In embodiments wherein the polymer is to be employed as a gel polymer layer, the thickness may be, for example, between about 1 micron and about 10 microns. In embodiments wherein the polymer is to be employed as a protective layer, the thickness may be, for example, about 1 microns. In some embodiments, the thickness of the protective layer may be greater than or equal to about 100 nm, greater than or equal to about 250 nm, greater than or equal to about 300 nm, greater than or equal to about 500 nm, greater than or equal to about 1 micron, greater than or equal to about 2 microns, greater than or equal to about 3 microns, greater than or equal to about 5 microns, or greater than or equal to about 7 microns. In certain embodiments, the thickness of the protective layer may be less than or equal to about 10 microns, less than or equal to about 7 microns, less than or equal to about 5 microns, less than or equal to about 3 microns, less than or equal to about 2 microns, less than or equal to about 1 micron, less than or equal to about 500 nm, less than or equal to about 300 nm, or less than or equal to about 250 nm. Combinations of the above-referenced ranges are also possible. For example, in one particular set of embodiments, the thickness of the protective layer may be between about 1 micron and about 5 microns, or between about 300 nm and about 3 microns. Other thicknesses are also possible.

As described herein, in some embodiments, ionic compounds (i.e., salts) may be included in the disclosed polymer compositions. In some embodiments, the conductivity of the polymer is determined in the swollen (e.g., gel) state. The gel state ion conductivity (i.e., the ion conductivity of the material when swollen with an electrolyte) of the polymer layers may vary over a range from, for example, about 10⁻⁷ S/cm to about 10⁻³ S/cm. In some embodiments, the gel state ion conductivity is between about 0.1 mS/cm and about 1 mS/cm, or between about 0.1 mS/cm and about 0.9 mS/cm, or between about 0.15 mS/cm and about 0.85 mS/cm. In certain embodiments, the gel state ion conductivity may be greater than or equal to 10⁻⁶ S/cm, greater than or equal to 10⁻⁵ S/cm, greater than or equal to 10⁻⁴ S/cm. In some embodiments, the gel state ion conductivity may be, for example, less than or equal to 10⁻³ S/cm, less than or equal to 10⁻⁴ S/cm, less than or equal to 10⁻⁵ S/cm. Combinations of the above-referenced ranges are also possible (e.g., a gel state ion conductivity of greater than or equal to greater than or equal to 10⁻⁵ S/cm and less than or equal to 10⁻³ S/cm). Other gel state ion conductivities are also possible. In some embodiments, the gel state conductivity may be determined in the electrolyte solvent to be used with the electrochemical cell. In some embodiments, the electrolyte is 8 wt % lithium bis trifluoromethanesulfonimide and 4 wt % LiNO₂ in a 1:1 mixture by weight of 1,2-dimethoxyethane and 1,3-dioxolane.

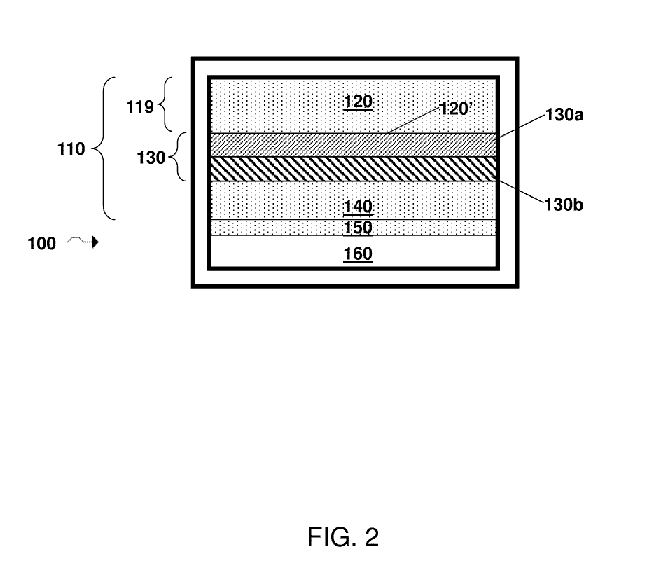

As shown in the embodiment illustrated in FIG. 2, article 110 comprising anode 119 may be incorporated with other components to form an electrochemical cell 100. The electrochemical cell may optionally include a separator 150 positioned adjacent or within the electrolyte. The electrochemical cell may further include a cathode 160 comprising a cathode active material. A protective structure 130 may be incorporated between an electroactive layer 120 and an electrolyte layer 140 and a cathode 160. As described herein, a cross-linked polymer may be used to form all or portions of a protective layer or structure, a separator, a polymer gel layer, or a release layer.

In some embodiments, the polymers disclosed herein may also be employed as a separator (e.g., separator 150 in FIG. 2). Generally, a separator is interposed between a cathode and an anode in an electrochemical cell. The separator may separates or insulates the anode and the cathode from each other preventing short circuiting, and which permits the transport of ions between the anode and the cathode. The separator may be porous, wherein the pores may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes.

In embodiments in which the polymer is used as a separator, the thickness of the polymer layer may be, for example, between about 1 micron and about 20 microns. In some embodiments, the thickness of the separator may be greater than or equal to about 1 micron, greater than or equal to about 2 micron, greater than or equal to about 5 micron, or greater than or equal to about 10 microns. In certain embodiments, the thickness of the separator may be less than or equal to about 20 microns, less than or equal to about 10 microns, less than or equal to about 5 microns, or less than or equal to about 2 microns. Combinations of the above-referenced ranges are also possible (e.g., a thickness of greater than about 2 microns and less than or equal to about 10 microns). Other thicknesses are also possible.

In some embodiments, the porosity of the separator can be, for example, at least 30%, at least 40%, at least 50%, at least 60%, at least 70%, at least 80%, or at least 90%. In certain embodiments, the porosity is less than 90%, less than 80%, less than 70%, less than 60%, less than 50%, less than 40%, or less than 30%. Other sizes are also possible. Combinations of the above-noted ranges are also possible.

In some embodiments, the polymers disclosed herein may be employed as a release layer. For example, in certain embodiments, the release layer is used in the fabrication of an electrode precursor. In some embodiments, the electrode precursor comprises an electroactive material (e.g., comprising lithium metal or lithium metal alloy), a carrier substrate, and one or more release layers comprising a polymer layer described herein. In some such embodiments, the electrode precursor structure comprises one or more release layers, wherein the one or more release layers is formed, or made more easily releasable, by exposing the release layer to a solvent.

In some embodiments, the polymer release layer is integrated into the electrochemical cell (e.g., the release layer remains attached to the electrode precursor structure after the release step, instead of remaining attached to the carrier substrate to which the electrode precursor was formed). In some such embodiments, the articles and methods described herein may also offer the advantage that the ion conductive layer (e.g., ceramic layer) of the released electrode is protected by a polymer layer (e.g. release layer) during subsequent handling procedures of the cell assembly. In certain embodiments, the polymer layer performs as a gel protection layer for the electrode.

In certain embodiments, the electrode precursor is formed by first positioning one or more release layers (e.g., comprising a polymer layer) on a surface of a carrier substrate. In some embodiments, the release layer serves to subsequently release the electrode from the carrier substrate so that the carrier substrate is not incorporated into the final electrochemical cell. To form the electrode, an electrode component such as an optional ion conducting layer can be positioned adjacent the release layer on the side opposite the carrier substrate. Subsequently, an electroactive material may be positioned adjacent the optional ion conducting layer, or on the release layer directly in embodiments in which the option ion conducting layer is not present. As such, in some embodiments, the electroactive material is positioned directly adjacent one or more release layers (e.g., comprising a polymer layer). In some embodiments, an optional current collector may be positioned on an adjacent surface of the electroactive material.

After the electrode precursor structure has been formed, the carrier substrate may be released from the electrode through the use of release layer. As described herein, this release process may be facilitated by exposing at least a portion of the electrode precursor structure, and/or the release layer within the structure, to a solvent and/or to the electrolyte. This exposure may, in some embodiments, reduce the adhesion of the release layer to one or more surfaces (e.g., a surface of the electroactive material, a surface of the carrier substrate). The release layer may be either released along with the carrier substrate so that the release layer is not a part of the final electrode structure, or the release layer may remain a part of the final electrode structure.

The positioning of the release layer during release of the carrier substrate can be varied by tailoring the chemical and/or physical properties of the release layer. For example, if it is desirable for the release layer to be part of the final electrode structure, the release layer may be tailored to have a greater adhesive affinity to the optional ion conducting layer or the electroactive material layer relative to its adhesive affinity to the carrier substrate. On the other hand, if it is desirable for the release layer to not be part of an electrode structure, the release layer may be designed to have a greater adhesive affinity to the carrier substrate relative to its adhesive affinity to the optional ion conducting layer or the electroactive material (e.g., when no ion conducting layer is present). In the latter case, when a peeling force is applied to the carrier substrate (and/or to the electrode), the release layer is released from the optional ion conducting layer or the electroactive material (e.g., when no ion conducting layer is present) and remains on the carrier substrate.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

The release layer (e.g., comprising a polymer layer as described herein) may be ionically conductive. In some cases, conductivity of the release layer may be provided either through intrinsic lithium ion conductivity of the material in the dry state, or the release layer may comprise a polymer that includes a salt (e.g., a polymer capable of being swollen by an electrolyte to form a gel polymer exhibiting conductivity in the wet state). In some embodiments, the polymer comprises an amorphous polymer. In certain embodiments, the release layer exhibits conductivities of greater than or equal to about 10⁻⁷ S/cm, greater than or equal to about 10⁻⁶ S/cm, greater than or equal to about 10⁻⁵ S/cm, greater than or equal to about 10⁻⁴ S/cm, greater than or equal to about 10⁻³ S/cm, greater than or equal to about 10⁻² S/cm, greater than or equal to about 10⁻¹ S/cm in either the dry or wet state. Correspondingly, the release layer preferably exhibits conductivities of less than or equal to about 10⁻¹ S/cm, less than or equal to about 10⁻² S/cm, less than or equal to about 10⁻³ S/cm in either the dry or wet state. Combinations of the above-referenced ranges are also possible (e.g., a conductivity of greater than or equal to about 10⁻⁴ S/cm and less than or equal to about 10⁻¹ S/cm).

In certain embodiments, the surface of a release layer (e.g., comprising the polymer layer) may be relatively smooth (e.g. have a relatively low surface roughness). A relatively smooth surface of the release layer may be produced, for example, by forming the release layer on a relatively smooth carrier substrate. In some embodiments, the surface of the release layer and/or a carrier substrate described herein has a mean peak to valley roughness (R_{z}) of less than or equal to about 2 μm, less than or equal to about 1.5 μm, less than or equal to about 1 μm, less than or equal to about 0.9 μm, less than or equal to about 0.8 μm, less than or equal to about 0.7 μm, less than or equal to about 0.6 μm, or less than or equal to about 0.5 μm. In certain embodiments, the surface of the release layer exhibits an R_{z}, of greater than or equal to about 0.1 μm, greater than or equal to about 0.2 μm, greater than or equal to about 0.4 μm, greater than or equal to about 0.6 μm, greater than or equal to about 0.8 μm, or greater than or equal to about 1 μm. Combinations of the above-referenced ranges are also possible (e.g., an R_{z}, of greater than or equal to about 0.1 μm and less than or equal to about 1 μm). In certain embodiments, the mean peak to valley roughness of the release layer is less than the mean peak to valley roughness of the carrier substrate.

The percent difference in adhesive strength between the release layer and the two surfaces (e.g., a carrier substrate and an ion conducting layer) with which the release layer is in contact may be calculated, for example, by taking the difference between the adhesive strengths at these two interfaces. In certain embodiments, the adhesive strength can be determined by a peel adhesion test (e.g., FINAT Test Method No. 2 (FTM 2)). Briefly, the peel adhesion test uses a tensile testing machine to measure the force required to peel a first layer (e.g., a polymer layer) from a second layer (e.g., an ion conducting layer, a carrier substrate), by removing the first layer from the second layer at a 90° angle at a constant speed (e.g., between about 0.505 mm per minute and about 1143 mm/min). Those skilled in the art would be capable of selecting an appropriate speed for the test based upon the relative adhesion strength and/or film mechanical strength of the first and second layers. In some embodiments, the adhesive strength was determined by a peel adhesion test by removing the first layer from the second layer at a 90° angle at a constant speed of about 254 mm/min.

For example, for a release layer positioned between two layers (e.g., between a carrier substrate and an ion conducting layer), the adhesive strength of the release layer on the first layer (e.g., a carrier substrate) can be calculated, and the adhesive strength of the release layer on the second layer (e.g., an ion conducting layer) can be calculated. The smaller adhesive strength can then be subtracted from the larger adhesive strength, and this difference divided by the larger adhesive strength to determine the percentage difference in adhesive strength between each of the two layers and the release layer. In some embodiments, the percent difference in adhesive strength is greater than or equal to about 20%, greater than or equal to about 30%, greater than or equal to about 40%, greater than or equal to about 50%, greater than or equal to about 60%, greater than or equal to about 70%, or greater than or equal to about 80%. In certain embodiments, the percent difference in adhesive strength is less than about 90%, less than about 80%, less than about 70%, less than about 60%, less than about 50%, less than about 40%, or less than about 30%. Combinations of the above-referenced ranges are also possible (e.g., the percent difference in adhesive strength is between about 20% and about 90%). The percentage difference in adhesive strength may be tailored by methods described herein, such as by choosing appropriate materials for each of the layers. In some cases, an adhesive strength between the release layer and the ion conducting layer may be greater than an adhesive strength between the release layer and the carrier substrate.

In some embodiments, adhesive strength may be assessed by a peel force test. In certain embodiments, to determine relative adhesion strength between two materials (e.g., a polymer layer and a carrier substrate and/or an optional ion conducting layer), a tape test can be performed. Briefly, the tape test utilizes pressure-sensitive tape to qualitatively asses the adhesion between a first layer (e.g., a polymer layer) and a second layer (e.g., an optional ion conductive layer, a carrier substrate). In such a test, an X-cut can be made through the first layer (e.g., a polymer layer) to the second layer (e.g., an ion conductive layer, a carrier substrate). Pressure-sensitive tape can be applied over the cut area and removed. If the polymer layer stays on the inorganic material layer, adhesion is good. If the polymer layer comes off with the strip of tape, adhesion is poor. The tape test may be performed according to the standard ASTM D3359-02. In some embodiments, a strength of adhesion between the polymeric material and the inorganic material passes the tape test according to the standard ASTM D3359-02, meaning the inorganic material does not delaminate from the polymer material (or vice versa) during the test.

In some embodiments, adhesion and/or release between a release layer and components of an electrochemical cell may comprise associations such as adsorption, absorption, Van der Waals interactions, hydrogen bonding, covalent bonding, ionic bonding, cross linking, electrostatic interactions, or combinations thereof. The type and degree of such interactions may also be tailored by methods described herein.

In certain embodiments, an electrode precursor structure as described herein comprises one or more release layers wherein an adhesive strength between the one or more release layers and the at least one ion conducting layer is greater than an adhesive strength between the one or more release layers and the carrier substrate.

In another set of embodiments, electrolyte layer 40, as shown illustratively in FIG. 1, may comprise a polymer gel formed from a polymer disclosed herein. In some embodiments, the polymer gel is formed by swelling at least a portion of the polymer in a solvent to form the gel. The polymers may be swollen in any appropriate solvent. The solvent may include, for example, dimethylacetamide (DMAc), N-methylpyrolidone (NMP), dimethylsulfoxide (DMSO), dimethylformamide (DMF), sulfolanes, sulfones, and/or any other appropriate solvent. Other solvents such as the liquid electrolytes described in more detail herein, can be used in some embodiments. In certain embodiments, the polymer may be swollen in a solvent mixture comprising a solvent having affinity to polymer and also solvents having no affinity to the polymer (so-called non-solvents). In some embodiments, the polymers are swellable in 1,2-dimethoxyethane and/or 1,3-dioxolane solvents. The solvents for preparing the polymer gel may be selected from the solvents described herein and may comprise electrolyte salts, including lithium salts selected from the lithium salts described herein.

In embodiments where more than one solvent is employed, the solvents may be present in any suitable ratio, for example, at a ratio of a first solvent to a second solvent of about 1:1, about 1.5:1, about 2:1, about 1:1.5, or about 1:2. In certain embodiments, the ratio of the first and second solvents may between 100:1 and 1:100, or between 50:1 and 1:50, or between 25:1 and 1:25, or between 10:1 and 1:10, or between 5:1 and 1:5. In some embodiments, the ratio of a first solvent to a second solvent is greater than or equal to about 0.2:1, greater than or equal to about 0.5:1, greater than or equal to about 0.8:1, greater than or equal to about 1:1, greater than or equal to about 1.2:1, greater than or equal to about 1.5:1, greater than or equal to about 1.8:1, greater than or equal to about 2:1, or greater than or equal to about 5:1. The ratio of a first solvent to a second solvent may be less than or equal to about 5:1, less than or equal to about 2:1, less than or equal to about 1.8:1, less than or equal to about 1.5:1, less than or equal to about 1.2:1, less than or equal to about 1:1, less than or equal to about 0.8:1, or less than or equal to about 0.5:1. Combinations of the above-referenced ranges are also possible (e.g., a ratio of greater than or equal to about 0.8:1 and less than or equal to about 1.5:1). In some embodiments, the first solvent is 1,2-dimethoxyethane and the second solvent is 1,3-dioxolane, although it should be appreciated that any of the solvents described herein can be used as first or second solvents. Additional solvents (e.g., a third solvent) may also be included.

In some embodiments, a polymer layer (e.g., a protective polymer layer or a polymer gel layer) and/or an electrolyte may include one or more ionic electrolyte salts, also as known in the art, to increase the ionic conductivity. In some embodiments, the salt can be selected from salts of lithium or sodium. In particular, if the anode or cathode contains lithium, the salt can be selected from lithium salts.

Suitable lithium salts may be selected from LiNO₃, LiPF₆, LiBF₄, LiClO₄, LiAsF₆, Li₂SiF₆, LiSbF₆, LiAlCl₄, lithium bis-oxalatoborate (LiBOB), LiCF₃SO₃, LiN(SO₂F)₂, LiC(CₙF₂ₙ₊₁SO₂)₃ wherein n is an integer in the range of from 1 to 20, and salts of the general formula (CₙF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicium (silicon) and n is an integer in the range of from 1 to 20. In certain embodiments, suitable salts may be selected from LiC(CF₃SO₂)₃, LiN(CF₃SO₂)₂, LiN(SO₂F)₂, LiPF₆, LiBF₄, LiClO₄, and LiCF₃SO₃. The concentration of salt in a solvent can be in the range of from about 0.5 to about 2.0 M, from about 0.7 to about 1.5 M, or from about 0.8 to about 1.2 M (wherein M signifies molarity, or moles per liter). The amount of salt can also vary when present in a layer (e.g., a polymer layer).

As shown illustratively in FIG. 1, in one set of embodiments, an article for use in an electrochemical cell may include an ion-conductive layer. In some embodiments, the -ion conductive layer is a ceramic layer, a glassy layer, or a glassy-ceramic layer, e.g., an ion conducting ceramic/glass conductive to lithium ions. Suitable glasses and/or ceramics include, but are not limited to, those that may be characterized as containing a “modifier” portion and a “network” portion, as known in the art. The modifier may include a metal oxide of the metal ion conductive in the glass or ceramic. The network portion may include a metal chalcogenide such as, for example, a metal oxide or sulfide. For lithium metal and other lithium-containing electrodes, an ion conductive layer may be lithiated or contain lithium to allow passage of lithium ions across it. Ion conductive layers may include layers comprising a material such as lithium nitrides, lithium silicates, lithium borates, lithium aluminates, lithium phosphates, lithium phosphorus oxynitrides, lithium silicosulfides, lithium germanosulfides, lithium oxides (e.g., Li₂O, LiO, LiO₂, LiRO₂, where R is a rare earth metal), lithium lanthanum oxides, lithium titanium oxides, lithium borosulfides, lithium aluminosulfides, and lithium phosphosulfides, and combinations thereof. The selection of the ion conducting material will be dependent on a number of factors including, but not limited to, the properties of electrolyte and cathode used in the cell.

In one set of embodiments, the ion conductive layer is a non-electroactive metal layer. The non-electroactive metal layer may comprise a metal alloy layer, e.g., a lithiated metal layer especially in the case where a lithium anode is employed. The lithium content of the metal alloy layer may vary from about 0.5% by weight to about 20% by weight, depending, for example, on the specific choice of metal, the desired lithium ion conductivity, and the desired flexibility of the metal alloy layer. Suitable metals for use in the ion conductive material include, but are not limited to, Al, Zn, Mg, Ag, Pb, Cd, Bi, Ga, In, Ge, Sb, As, and Sn. Sometimes, a combination of metals, such as the ones listed above, may be used in an ion conductive material.

The thickness of an ion conductive material layer may vary over a range from about 1 nm to about 10 microns. For instance, the thickness of the ion conductive material layer may be between 1-10 nm thick, between 10-100 nm thick, between 100-1000 nm thick, between 1-5 microns thick, or between 5-10 microns thick. In some embodiments, the thickness of an ion conductive material layer may be, for example, less than or equal to 10 microns, less than or equal to 5 microns, less than or equal to 1000 nm, less than or equal to 500 nm, less than or equal to 250 nm, less than or equal to 100 nm, less than or equal to 50 nm, less than or equal to 25 nm, or less than or equal to 10 nm. In certain embodiments, the ion conductive layer may have a thickness of greater than or equal to 10 nm, greater than or equal to 25 nm, greater than or equal to 50 nm, greater than or equal to 100 nm, greater than or equal to 250 nm, greater than or equal to 500 nm, greater than or equal to 1000 nm, or greater than or equal to 1500 nm. Combinations of the above-referenced ranges are also possible (e.g., a thickness of greater than or equal to 10 nm and less than or equal to 500 nm). Other thicknesses are also possible. In some cases, the ion conductive layer has the same thickness as a polymer layer.

The ion conductive layer may be deposited by any suitable method such as sputtering, electron beam evaporation, vacuum thermal evaporation, laser ablation, chemical vapor deposition (CVD), thermal evaporation, plasma enhanced chemical vacuum deposition (PECVD), laser enhanced chemical vapor deposition, and jet vapor deposition. The technique used may depend on the type of material being deposited, the thickness of the layer, etc. In some embodiments, the ion conductive material is non-polymeric. In certain embodiments, the ion conductive material is defined in part or in whole by a layer that is highly conductive toward lithium ions (or other ions) and minimally conductive toward electrons. In other words, the ion conductive material may be one selected to allow certain ions, such as lithium ions, to pass across the layer, but to impede electrons, from passing across the layer. In some embodiments, the ion conductive material forms a layer that allows only a single ionic species to pass across the layer (i.e., the layer may be a single-ion conductive layer). In other embodiments, the ion conductive material may be substantially conductive to electrons. In one set of embodiments, the ion conductive layer is a ceramic layer, a glassy layer, or a glassy-ceramic layer, e.g., an ion-conducting glass conductive to ions (e.g., lithium ions). For lithium metal and other lithium-containing electrodes, an ion conductive layer may be lithiated or contain lithium to allow passage of lithium ions across it. Ion conductive layers may include layers comprising a material such as lithium nitrides, lithium silicates, lithium borates, lithium aluminates, lithium phosphates, lithium phosphorus oxynitrides, lithium silicosulfides, lithium germanosulfides, lithium oxides (e.g., Li₂O, LiO, LiO₂, LiRO₂, where R is a rare earth metal), lithium lanthanum oxides, lithium titanium oxides, lithium borosulfides, lithium aluminosulfides, and lithium phosphosulfides, and combinations thereof. The selection of the ion conducting material will be dependent on a number of factors including, but not limited to, the properties of electrolyte and cathode used in the cell.

The ion conductive layer may be deposited by any suitable method such as sputtering, electron beam evaporation, vacuum thermal evaporation, laser ablation, chemical vapor deposition (CVD), thermal evaporation, plasma enhanced chemical vacuum deposition (PECVD), laser enhanced chemical vapor deposition, and jet vapor deposition. The technique used may depend on the type of material being deposited, the thickness of the layer, etc.

In some embodiments, an electrode precursor structure described herein comprises at least one current collector. Materials for the current collector may be selected, in some cases, from metals (e.g., copper, nickel, aluminum, passivated metals, and other appropriate metals), metallized polymers, electrically conductive polymers, polymers comprising conductive particles dispersed therein, and other appropriate materials. In certain embodiments, the current collector is deposited onto the electrode layer using physical vapor deposition, chemical vapor deposition, electrochemical deposition, sputtering, doctor blading, flash evaporation, or any other appropriate deposition technique for the selected material. In some cases, the current collector may be formed separately and bonded to the electrode structure. It should be appreciated, however, that in some embodiments a current collector separate from the electroactive layer may not be needed.

In certain embodiments, the electrode precursor structure as described herein, further comprises at least one Li ion conducting layer, wherein the at least one Li ion conducting layer is a ceramic layer, wherein the thickness of the at least one Li ion conducting layer is greater (e.g., at least two times greater) than the mean peak to valley roughness of one or more release layers. In some embodiments, the electrode precursor structure as described herein, comprises at least one Li ion conducting layer wherein the thickness of the at least one Li ion conducting layer is between 0.1 μm and 5 μm. In some cases, the electrode precursor structure as described herein, may comprise at least one Li metal layer. In some embodiments, the electrode precursor structure as described herein comprises at least one current collector.

As shown illustratively in FIG. 1, an electrochemical cell or an article for use in an electrochemical cell may include a cathode active material layer. Suitable electroactive materials for use as cathode active materials in the cathode of the electrochemical cells described herein may include, but are not limited to, electroactive transition metal chalcogenides, electroactive conductive polymers, sulfur, carbon, and/or combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of poolypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of this invention may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

In certain embodiments, the sulfur-containing material (e.g., in an oxidized form) comprises a polysulfide moiety, Sm, selected from the group consisting of covalent Sm moieties, ionic Sm moieties, and ionic Sm²⁻ moieties, wherein m is an integer equal to or greater than 3. In some embodiments, m of the polysulfide moiety Sm of the sulfur-containing polymer is an integer equal to or greater than 6 or an integer equal to or greater than 8. In some cases, the sulfur-containing material may be a sulfur-containing polymer. In some embodiments, the sulfur-containing polymer has a polymer backbone chain and the polysulfide moiety Sm is covalently bonded by one or both of its terminal sulfur atoms as a side group to the polymer backbone chain. In certain embodiments, the sulfur-containing polymer has a polymer backbone chain and the polysulfide moiety Sm is incorporated into the polymer backbone chain by covalent bonding of the terminal sulfur atoms of the polysulfide moiety.

In some embodiments, the electroactive sulfur-containing material comprises more than 50% by weight of sulfur. In certain embodiments, the electroactive sulfur-containing material comprises more than 75% by weight of sulfur (e.g., more than 90% by weight of sulfur).

As will be known by those skilled in the art, the nature of the electroactive sulfur-containing materials described herein may vary widely. In some embodiments, the electroactive sulfur-containing material comprises elemental sulfur. In certain embodiments, the electroactive sulfur-containing material comprises a mixture of elemental sulfur and a sulfur-containing polymer.

In certain embodiments, an electrochemical cell as described herein, comprises one or more cathodes comprising sulfur as a cathode active species. In some such embodiments, the cathode includes elemental sulfur as a cathode active species.

Suitable electroactive materials for use as anode active materials in the electrochemical cells described herein include, but are not limited to, lithium metal such as lithium foil and lithium deposited onto a conductive substrate, and lithium alloys (e.g., lithium-aluminum alloys and lithium-tin alloys). Lithium can be contained as one film or as several films, optionally separated by a protective material such as a ceramic material or an ion conductive material described herein. Suitable ceramic materials include silica, alumina, or lithium containing glassy materials such as lithium phosphates, lithium aluminates, lithium silicates, lithium phosphorous oxynitrides, lithium tantalum oxide, lithium aluminosulfides, lithium titanium oxides, lithium silcosulfides, lithium germanosulfides, lithium aluminosulfides, lithium borosulfides, and lithium phosphosulfides, and combinations of two or more of the preceding. Suitable lithium alloys for use in the embodiments described herein can include alloys of lithium and aluminum, magnesium, silicium (silicon), indium, and/or tin. While these materials may be preferred in some embodiments, other cell chemistries are also contemplated. In some embodiments, the anode may comprise one or more binder materials (e.g., polymers, etc.).

The articles described herein may further comprise a substrate, as is known in the art. Substrates are useful as a support on which to deposit the anode active material, and may provide additional stability for handling of thin lithium film anodes during cell fabrication. Further, in the case of conductive substrates, a substrate may also function as a current collector useful in efficiently collecting the electrical current generated throughout the anode and in providing an efficient surface for attachment of electrical contacts leading to an external circuit. A wide range of substrates are known in the art of anodes. Suitable substrates include, but are not limited to, those selected from the group consisting of metal foils, polymer films, metallized polymer films, electrically conductive polymer films, polymer films having an electrically conductive coating, electrically conductive polymer films having an electrically conductive metal coating, and polymer films having conductive particles dispersed therein. In one embodiment, the substrate is a metallized polymer film. In other embodiments, described more fully below, the substrate may be selected from non-electrically-conductive materials.

In certain embodiments, the electrochemical cell comprises an electrolyte. The electrolytes used in electrochemical or battery cells can function as a medium for the storage and transport of ions, and in the special case of solid electrolytes and gel electrolytes, these materials may additionally function as a separator between the anode and the cathode. Any suitable liquid, solid, or gel material capable of storing and transporting ions may be used, so long as the material facilitates the transport of ions (e.g., lithium ions) between the anode and the cathode. The electrolyte is electronically non-conductive to prevent short circuiting between the anode and the cathode. In some embodiments, the electrolyte may comprise a non-solid electrolyte.

In some embodiments, a cross-linked polymer described herein can be used to form all or portions of an electrolyte (e.g., a solid electrolyte or a gel electrolyte). However, in other embodiments, one or more other materials can be used as an electrolyte as described in more detail below.

In some embodiments, an electrolyte is in the form of a layer having a particular thickness. An electrolyte layer described herein may have a thickness of, for example, at least 1 micron, at least 5 microns, at least 10 microns, at least 15 microns, at least 20 microns, at least 25 microns, at least 30 microns, at least 40 microns, at least 50 microns, at least 70 microns, at least 100 microns, at least 200 microns, at least 500 microns, or at least 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 50 microns. Other values are also possible. Combinations of the above-noted ranges are also possible.

In some embodiments, the electrolyte includes a non-aqueous electrolyte. Suitable non-aqueous electrolytes may include organic electrolytes such as liquid electrolytes, gel polymer electrolytes, and solid polymer electrolytes. These electrolytes may optionally include one or more ionic electrolyte salts (e.g., to provide or enhance ionic conductivity) as described herein. Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, acyclic ethers, cyclic ethers, glymes, polyethers, phosphate esters, siloxanes, dioxolanes, N-alkylpyrrolidones, substituted forms of the foregoing, and blends thereof. Examples of acyclic ethers that may be used include, but are not limited to, diethyl ether, dipropyl ether, dibutyl ether, dimethoxymethane, trimethoxymethane, dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents.

In some cases, mixtures of the solvents described herein may also be used. For example, in some embodiments, mixtures of solvents are selected from the group consisting of 1,3-dioxolane and dimethoxyethane, 1,3-dioxolane and diethyleneglycol dimethyl ether, 1,3-dioxolane and triethyleneglycol dimethyl ether, and 1,3-dioxolane and sulfolane. The weight ratio of the two solvents in the mixtures may range, in some cases, from about 5 wt %:95 wt % to 95 wt %:5 wt %.

Non-limiting examples of suitable gel polymer electrolytes include polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, crosslinked and network structures of the foregoing, and blends of the foregoing.

Non-limiting examples of suitable solid polymer electrolytes include polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In some embodiments, the non-aqueous electrolyte comprises at least one lithium salt. For example, in some cases, the at least one lithium salt is selected from the group consisting of LiNO₃, LiPF₆, LiBF₄, LiClO₄, LiAsF₆, Li₂SiF₆, LiSbF₆, LiAlCl₄, lithium bis-oxalatoborate, LiCF₃SO₃, LiN(SO₂F)₂, LiC(CₙF₂ₙ₊₁SO₂)₃, wherein n is an integer in the range of from 1 to 20, and (CₙF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicon.

In some cases, the electrochemical cell is fabricated by contacting an electrode structure as described herein with a non-aqueous electrolyte. The electrode structure may comprise one or more polymer layers. Contact with a non-aqueous electrolyte may at least partially dissolve the one or more polymer layers in the non-aqueous electrolyte. In some embodiments, the one or more polymer layers is completely dissolved in the non-aqueous electrolyte.

In some embodiments, an electrode structure described herein is fabricated by depositing one or more polymer layers on a carrier substrate and depositing one or more electroactive materials (e.g., comprising lithium metal or lithium alloy) on the one or more polymer layers. In some embodiments, at least one ion conductive ceramic layer is deposited on the one or more polymer layers prior to deposition of the electroactive material. Alternatively, at least one ion conductive ceramic layer may be deposited on the carrier substrate, followed by a polymer layer, followed by an electroactive material. In some embodiments, one or more one current collectors may optionally be deposited on the at least one electroactive material. In certain embodiments, the carrier substrate may be removed from the one or more polymer layers, forming the electrode structure. Other configurations are also possible.

In some embodiments, the carrier substrate is made from a polymeric material. In certain embodiments, the carrier substrate comprises a polyester such as a polyethylene terephthalate (PET) (e.g., optical grade polyethylene terephthalate), polyolefins, polypropylene, nylon, polyvinyl chloride, and polyethylene (which may optionally be metalized). In some embodiments, the carrier substrate comprises a metal or a ceramic material.

The term “aliphatic,” as used herein, includes both saturated and unsaturated, straight chain (i.e., unbranched), branched, acyclic, cyclic, or polycyclic aliphatic hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched, and cyclic alkyl groups. An analogous convention applies to other generic terms such as “alkenyl,” “alkynyl,” and the like. Furthermore, as used herein, the terms “alkyl,” “alkenyl,” “alkynyl,” and the like encompass both substituted and unsubstituted groups. In certain embodiments, as used herein, “lower alkyl” is used to indicate those alkyl groups (cyclic, acyclic, substituted, unsubstituted, branched or unbranched) having 1-6 carbon atoms.

In certain embodiments, the alkyl, alkenyl, and alkynyl groups employed in the compounds described herein contain 1-20 aliphatic carbon atoms. For example, in some embodiments, an alkyl, alkenyl, or alkynyl group may have greater than or equal to 2 carbon atoms, greater than or equal to 4 carbon atoms, greater than or equal to 6 carbon atoms, greater than or equal to 8 carbon atoms, greater than or equal to 10 carbon atoms, greater than or equal to 12 carbon atoms, greater than or equal to 14 carbon atoms, greater than or equal to 16 carbon atoms, or greater than or equal to 18 carbon atoms. In some embodiments, an alkyl, alkenyl, or alkynyl group may have less than or equal to 20 carbon atoms, less than or equal to 18 carbon atoms, less than or equal to 16 carbon atoms, less than or equal to 14 carbon atoms, less than or equal to 12 carbon atoms, less than or equal to 10 carbon atoms, less than or equal to 8 carbon atoms, less than or equal to 6 carbon atoms, less than or equal to 4 carbon atoms, or less than or equal to 2 carbon atoms. Combinations of the above-noted ranges are also possible (e.g., greater than or equal to 2 carbon atoms and less than or equal to 6 carbon atoms). Other ranges are also possible.

Illustrative aliphatic groups include, but are not limited to, for example, methyl, ethyl, n-propyl, isopropyl, cyclopropyl, —CH₂-cyclopropyl, vinyl, allyl, n-butyl, sec-butyl, isobutyl, tert-butyl, cyclobutyl, —CH₂-cyclobutyl, n-pentyl, sec-pentyl, isopentyl, tert-pentyl, cyclopentyl, —CH₂-cyclopentyl, n-hexyl, sec-hexyl, cyclohexyl, —CH₂-cyclohexyl moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl, and the like. The term “alkoxy,” or “thioalkyl” as used herein refers to an alkyl group, as previously defined, attached to the parent molecule through an oxygen atom or through a sulfur atom. In certain embodiments, the alkoxy or thioalkyl groups contain a range of carbon atoms, such as the ranges of carbon atoms described herein with respect to the alkyl, alkenyl, or alkynyl groups. Examples of alkoxy, include but are not limited to, methoxy, ethoxy, propoxy, isopropoxy, n-butoxy, tert-butoxy, neopentoxy, and n-hexoxy. Examples of thioalkyl include, but are not limited to, methylthio, ethylthio, propylthio, isopropylthio, n-butylthio, and the like.

The term “cycloalkyl,” as used herein, refers specifically to groups having three to seven, preferably three to ten carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or heterocyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “heteroaliphatic”, as used herein, refers to aliphatic moieties that contain one or more oxygen, sulfur, nitrogen, phosphorus, or silicon atoms, e.g., in place of carbon atoms. Heteroaliphatic moieties may be branched, unbranched, cyclic or acyclic and include saturated and unsaturated heterocycles such as morpholino, pyrrolidinyl, etc. In certain embodiments, heteroaliphatic moieties are substituted by independent replacement of one or more of the hydrogen atoms thereon with one or more moieties including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “independently selected” is used herein to indicate that the R groups can be identical or different.

### EXAMPLES

Non-limiting examples of the polymers described herein are illustrated by the following working examples.

### Example 1

### 1. Preparation of Branched Polyimides

### 1.1 Synthesis

Table 1 summarizes the polymers obtained from the syntheses described below. The hydroxyl (OHZ), the amine number and the acid number (CO₂H) along with molecular weights were determined by GPC and were evaluated for the polymerization products. The GPC results show for most products comparable molecular weights (Mₙ/M_{w}) thus indicating a reproducible reaction.

TABLE 1
Properties of evaluated polyalkyleneoxide block polyimides

| | | | | OHZ | —CO₂H | —NH₂ |
|---|---|---|---|---|---|---|
| Reaction | | Mₙ | M_{w} | [mg | [mg | [mg |
| Product | additive | [g/mol] | [g/mol] | KOH/g] | KOH/g] | KOH/g] |
| RP.1 | Taurin | 2800 | 6170 | — | 38 | 14 |
| RP.2 | Taurin | 2900 | 6390 | — | 37 | 17 |
| RP.3 | Octa-DA | 13900 | 27000 | — | 83 | 55 |

### 1.2-1 Preparation of Amine Modified Branched Polyimide RP.1:

An amount of 55 g (0.253 mol) of dianhydride of 1,2,4,5-benzene tetracarboxylic acid were dissolved in 750 ml of acetone which was not dried before the reaction and therefore comprised water and placed in a 4-1 four-neck flask having a dropping funnel, reflux cooler, internal thermometer and Teflon agitator. Then, 63 g (0.253 mol) of 4,4′-diphenylmethane diisocyanate were added drop wise at 20° C. The mixture was heated with stirring to 55° C. The mixture was stirred for a further five hours under reflux at 55° C. and 18 hours at room temperature. Thereafter a mixture of 10 g of taurine (2-aminoethanesulfonic acid) (0.082 mol), 170 g of Jeffamin® M 2070 (0.082 mol) and 220 g NMP was added at room temperature. The temperature was increased to 55° C. and stirred for two hours. Then acetone was distilled off at atmospheric pressure in the course of 4 hours. The produced reaction product is a red solution in NMP (solid content 59%).

Mₙ=2800 g/mol, M_{w}=6170 g/mol
M_{w}/Mₙ=2.2
Acid value: 38 mg KOH/g

### Amino-value: 14 mg KOH/g

### 1.2-2 Preparation of Reaction Product RP.2:

An amount of 40 g (0.184 mol) of dianhydride of 1,2,4,5-benzene tetracarboxylic acid were dissolved in 520 ml of acetone (which was not dried before the reaction and therefore comprised water) and placed in a 4-1 four-neck flask having a dropping funnel, reflux cooler, internal thermometer and Teflon agitator. Then, 46 g (0.184 mol) of 4,4′-diphenylmethane diisocyanate were added drop wise at 20° C. The mixture was heated with stirring to 55° C. The mixture was stirred for a further five hours under reflux at 55° C. and 18 hours at room temperature. Thereafter a mixture of 3 g of taurine (0.024 mol), 198 g of Jeffamin® M 2070 (0.095 mol) and 220 g NMP was added at room temperature. The temperature was increased to 55° C. and stirred for one hours. Then acetone was distilled off at atmospheric pressure in the course of 6 hours. The produced reaction product is a red solution in NMP (solid content 53%).

Mₙ=2900 g/mol, M_{w}=6390 g/mol
M_{w}/Mₙ=2,2
Acid value: 37 mg KOH/g

### Amino-value: 17 mg KOH/g

### 1.2-3: Preparation of Reaction Product RP.3:

An amount of 25 g (0.115 mol) of dianhydride of 1,2,4,5-benzene tetracarboxylic acid were dissolved in 300 ml of acetone (which was not dried before the reaction and therefore comprised water) and placed in a 4-1 four-neck flask having a dropping funnel, reflux cooler, internal thermometer and Teflon agitator. Then, 29 g (0.115 mol) of 4,4′-diphenylmethane diisocyanate were added drop wise at 20° C. The mixture was heated with stirring to 55° C. The mixture was stirred for a further five hours under reflux at 55° C. and 18 hours at room temperature. Thereafter a mixture of 10 g of octadecylamine (Octa-DA, 0.0375 mol), 78 g of Jeffamin® M 2070 (0.0375 mol) and 150 g toluene was added at room temperature. The temperature was increased to 55° C. and stirred for three hours. Then acetone and toluene were distilled off at 85° C. and a pressure of 200 mbar. The produced reaction product is a red solid.

Mₙ=13900 g/mol, M_{w}=27700 g/mol
M_{w}/Mₙ=1,7
Acid value: 83 mg KOH/g
Amino value: 55 mg KOH/g

### 1.3 Preparation of Polymer Films

The synthesized polyalkyleneoxide block polyimides obtained were dissolved in N-methylpyrrolidone (NMP) and the solid content adjusted to 30 wt %. To the resulting polymer solutions Lupranat M20W was added and the mixtures obtained were applied at 80° C. with a doctor blade method to a glass plate. The obtained solvent-containing films had a thickness of 50 to 100 μm. Then the NMP was allowed to evaporate for 10 minutes at 80° C. To obtain free standing films, the coated glass plate was immersed in a water bath having room temperature for 1 hour. Then, the free standing films were removed manually and dried over a period of 24 hours under vacuum at 80° C. The free standing films obtained are listed in Table 2. These films may be suitable for use as separators and/or polymer gel layers. Polymer release layer coated substrates with thickness from 5 to 30 μm can be directly obtained by coating with polymer solutions and subsequent removal of the NMP at 80° C. for 10 minutes.

### 1.4 Lithium Ion Conductivity

The evaluation of lithium ion conductivity (σ) was performed in Pouch cells (10 cm×10 cm) with nickel electrodes. The films were placed in between two nickel plates (3.6 cm×3.4 cm) and a Celgard 2325 separator or directly coated nickel electrodes were used. Then 0.5 ml electrolyte 1,2-dimethyl ether/1,3-dioxolane (1:1, vol, vol), 16 wt % lithium bis trifluoromethane sulfonimide (LiTFSI), 4 wt % LiNO₂ and 1 wt % guanidiumnitrate (DD 16-4-1) were added before the Pouch bag was sealed. The pure electrolyte conductivity DD 16-4-1 accounts for 8.37×10⁻³ S/cm.

The cells were allowed to rest for two hours to complete the solvent take up. 5 kg weight were placed to exert pressure on the cell (5 kg/15 cm²=0.33 kg/cm²) then the ionic conductivity of the film was determined using impedance spectroscopy (Zahner IM6eX) in the frequency range from 10 Hz to 1 Mhz with an amplitude of 50 mV. From the Nyquist diagram the ohmic resistance was determined and the conductivity of the film calculated. Table 2 summarizes the results obtained.

TABLE 2
Conductivities of polyalkyleneoxide block polyimide film

| Reaction | | Thickness | |
|---|---|---|---|
| Product | composition | [μm] | σ [S/cm] |
| RP.1 | M2070/Taurin (1:1) | 81 | 1.1 × 10⁻³ |
| RP.2 | M2070/Taurin (4:1) | 81 | 7.8 × 10⁻⁴ |
| RP.3 | M2070/Octa-DA (1:1) | 110 | 1.0 × 10⁻³ |

### 2. Results and Discussion

### 2.1 Swelling Ability

In order to quantify the degree of electrolyte uptake, crosslinked film samples with 2 cm diameter were punched out and exposed for two days to DD 16-4-1 electrolyte solution. The weight of the films before and after exposure to the electrolyte were measured. In the swollen state, each of the films was very soft but could be handled. The weight of each of the films increased by between 559% and 1166%. As result, the swollen samples electrolyte contents from 85 to 90 wt % were found (Table 3). This example shows that these particular polyalkyleneoxide block polyimide films could be used as a polymer gel layer in an electrode structure or electrochemical cell described herein.

TABLE 3
Electrolyte uptake of polyalkyleneoxide block polyimides

| | | | after | Increase in |
|---|---|---|---|---|
| Reaction | | dry weight | electrolyte | weight |
| Product | Composition | [mg] | [mg] | percent |
| RP.1 | M2070/Taurin (1:1) | 9.3 | 90.6 | 874% |
| RP.2 | M2070/Taurin (4:1) | 6.8 | 86.1 | 1166% |
| RP.3 | M2070/Octa-DA (1:1) | 9.3 | 61.3 | 559% |

### 2.2 Adhesion Properties—Releasability

All crosslinked polyalkyleneoxide block polyimide films were subjected to simple testing procedure regarding their release ability. The release ability on optical grade PET and glass surface was tested by peeling off a Tesa tape sticking on the polymer surface. Table 4 summarizes the release properties depending on their composition. As result, none of the polyalkyleneoxide block polyimide films showed releasability from glass substrate. In contrast, M2070/Taurin (1:1) and (4:1) polyalkyleneoxide block polyimide films were releasable from PET substrate, indicating that these films could be used as release layers as described herein. However, M2070/Octa-DA (1:1) composition does not show releasability.

TABLE 4
Adhesion properties of polyalkyleneoxide block polyimides

| Reaction | | Release | Release |
|---|---|---|---|
| Product | Composition | PET | glass |
| RP.1 | M2070/Taurin (1:1) | ✓ | x |
| RP.2 | M2070/Taurin (4:1) | ✓ | x |
| RP.3 | M2070/Octa-DA (1:1) | x | x |

(✓ release, x no release)

### 2.3 Polysulfide Stability

Polyimide films samples (0.1˜0.15 g) were placed in 50 ml sample vials and 8 g of polysulfide solution (0.5 mol Li₂S₆) in 1,2-dimethoxyethane were added and the sealed sample vials were heated at 70° C. for 72 hours. The polyimide films were removed and washed with 1,2-dimethoxyethane for 24 hours at 70° C. After rinsing with 1,2-dimethoxyethane the polymer films were dried at 80° C. under vacuum for 72 hours. The weight was estimated and the weight loss calculated. In addition, the structural integrity (stability) of the film was judged.

Table 5 summarizes the results obtained. A weight loss of 13.5 wt % has been observed for RP.1 indicating instability against nucleophilic polysulfides. In contrast, RP.2 (M2070/Taurin) and RP.3 (M2070/Octa-DA) showed weight losses of only 0.7 wt % and 2.0 wt %, respectively. Although, RP.1 and RP.2 contain both Jeffamine M2070 and taurin as building blocks in different ratios, the weight loss of 13.5 wt % for the 1:1 composition might originate from leaching out of incomplete incorporated taurin building blocks. For Jeffamine M2070/Taurin ratios of 4:1 only a weight loss of 0.7 wt % was found. In addition, visual inspection indicates the structural integrity of all of these polyalkyleneoxide block polyimides.

This example shows that these particular polyalkyleneoxide block polyimide films show good structural integrity (e.g., stability) in the presence of a polysulfide solution.

TABLE 5
Polysulfide stability of polyalkyleneoxide block polyimides

| Reaction | | Weight | Visual |
|---|---|---|---|
| Product | composition | loss [%] | inspection |
| RP.1 | M2070/Taurin (1:1) | 13.5 | less stable |
| RP.2 | M2070/Taurin (4:1) | 0.7 | stable |
| RP.3 | M2070/Octa-DA (1:1) | 2.0 | stable |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An electrode structure comprising:
an electrode comprising lithium metal or lithium alloy;
a polymer layer comprising a cross-linked polymeric material formed by reaction of
(aa) a polymeric material formed by reaction of
(a) at least one polyimide selected from condensation products of:
(a1) at least one polyisocyanate having on average at least two isocyanate groups per molecule; and
(a2) at least one polycarboxylic acid having at least 3 COOH groups per molecule or an anhydride thereof; and
(b) at least one organic amine comprising at least one primary or secondary amino group, or a mixture of at least one organic amine comprising at least one primary or secondary amino group and at least one diol or triol; and
(bb) at least one polyisocyanate having on average at least two isocyanate groups per molecule.

2. The electrode structure according to claim 1, wherein the at least one polyimide (a) is selected from those polyimides that have a molecular weight M_{w} of at least 1000 g/mol.

3. The electrode structure according to claim 1, wherein the at least one polyimide (a) has a polydispersity M_{w}/Mₙ of at least 1.4.

4. The electrode structure according to claim 1, wherein the at least one polyisocyanate (a1) is selected from hexamethylene diisocyanate, tetramethylene diisocyanate, isophorone diisocyanate, 4,4′-diphenylmethane diisocyanate, 2,4′-diphenylmethane diisocyanate, toluylene diisocyanate and mixtures of at least two of the abovementioned at least one polyisocyanates (a1).

5. The electrode structure according to claim 1, wherein the at least one polyisocyanate (a1) is selected from oligomeric hexamethylene diisocyanate, oligomeric tetramethylene diisocyanate, oligomeric isophorone diisocyanate, oligomeric diphenylmethane diisocyanate, trimeric toluylene diisocyanate and mixtures of at least two of the abovementioned at least one polyisocyanates (a1).

6. The electrode structure according claim 1, wherein the at least one polycarboxylic acid (a2), or an anhydride or ester thereof, has at least 4 COOH groups per molecule.

7. The electrode structure according to claim 1, wherein polyisocyanate (a1) and polycarboxylic acid (a2) or anhydride (a2) are used in a quantitative ratio such that the molar fraction of NCO groups to COOH groups is in the range from 1:2 to 2:1, wherein one anhydride group of the formula CO—O—CO counts as two COOH groups.

8. The electrode structure according to claim 1, wherein the at least one organic amine (b) is selected from amines comprising one, two or three, primary or secondary amino groups, wherein the molecular weight of the amines is in the range from 31 to 10000 g/mol.

9. The electrode structure according to claim 1, wherein the at least one organic amine (b) is selected from polyetheramines, aliphatic amines with a C₁₀ to C₃₀-alkyl group and organic acids comprising at least one primary or secondary amino group.

10. The electrode structure according to claim 1, wherein the polymeric material (aa) has an acid value in the range from 0 to 200 mg of KOH/g.

11. The electrode structure according to claim 1, wherein the polymeric material (aa) has a molecular weight M_{w} of at least 1000 g/mol.

12. The electrode structure according to claim 1, wherein the polymer layer has a surface adjacent the electrode and having a mean peak to valley roughness of between 0.1 μm and 1 μm.

13. The electrode structure according to claim 1, wherein the polymer layer has a thickness in the range of from 1 to 20 μm, preferably in the range of from 1 to 10 μm.

14. The electrode structure according to claim 1, further comprising a current collector.

15. The electrode structure according to claim 1, further comprising an ion conductive ceramic layer.

16. The electrode structure according to claim 1, further comprising as component (F) a carrier substrate contacting component (D).

17. The electrode structure according to claim 16, wherein the carrier substrate is selected from the group consisting of polymer films, metalized polymer films, ceramic films and metal films.

18. A lithium sulfur electrochemical cell comprising at least one electrode structure according to claim 1.

19. The lithium sulfur electrochemical cell according to claim 18, further comprising at least one non-aqueous electrolyte.

20-29. (canceled)

30. A method for fabricating an electrode structure, comprising:
positioning on an electrode a polymer layer comprising a cross-linked polymeric material formed by reaction of:
(aa) a polymeric material formed by reaction of
(a) at least one polyimide selected from condensation products of:
(a1) at least one polyisocyanate having on average at least two isocyanate groups per molecule; and
(a2) at least one polycarboxylic acid having at least 3 COOH groups per molecule or an anhydride thereof; and
(b) at least one organic amine comprising at least one primary or secondary amino group, or a mixture of at least one organic amine comprising at least one primary or secondary amino group and at least one diol or triol; and
(bb) at least one polyisocyanate having on average at least two isocyanate groups per molecule.
